(19) United States
(12) Patent Application Publication
(10) Pub. No.: US 2018/0194907 A1
(43) Pub. Date: Jul. 12, 2018

(54) HIGH FATIGUE THERMOPLASTIC FORMULATIONS

(71) Applicant: SABIC Global Technologies B.V., Bergen op Zoom (NL)

(72) Inventors: Domenico LA CAMERA, Breda (NL); Erik SCHWARTZ, Nijmegen (NL); Robert Dirk VAN DE GRAMPEL, Tholen (NL); Ronald LUIJTEN, Oosterhout (NL)

(21) Appl. No.: 15/741,521

(22) PCT Filed: Jun. 27, 2016
(86) PCT No.: PCT/IB2016/053831

§ 371 Date: Jan. 3, 2018

Related U.S. Application Data
(60) Provisional application No. 62/189,025, filed on Jul. 6, 2015.

(51) Int. Cl. C08J 3/24; C08J 3/28; C08K 3/04; C08K 5/101; C08K 5/3492; C08K 7/14; C08L 27/18; C08L 69/00; C08L 71/12; C08L 77/00; C08L 79/08; C08L 83/04

(52) U.S. Cl. CPC C08J 3/247; C08J 3/28; C08K 3/041; C08K 3/042; C08K 5/101; C08K 5/34924; C08L 2205/16; C08L 27/18; C08L 69/00; C08L 71/123; C08L 77/00; C08L 79/08; C08L 83/04; C08K 7/14

(57) ABSTRACT

The disclosure concerns compositions comprising: from about 40 wt. % to about 99.5 wt. % of a polymer base resin; N from 0 wt. % to about 60 wt. % of a reinforcing filler; from 0 wt. % to about 25 wt. % of a lubricant; and from about 0.05 wt. % to about 6 wt. % of a cross-linking agent; wherein the composition is treated to induce cross-linking, wherein the combined weight percent value of all components does not exceed 100 wt % and wherein the composition shows improved tensile fatigue versus a corresponding composition without the cross-linking agent.

### RELATED APPLICATIONS

This application claims benefit of U.S. Patent Application No. 62/189,025 filed on Jul. 6, 2016, the disclosure of which is incorporated herein in its entirety.

### TECHNICAL FIELD

The disclosure concerns high fatigue thermoplastic formulations, articles comprising such formulations, and method of making such formulations.

### BACKGROUND

Fatigue resistance and fatigue life are important characteristics of thermoplastic materials used in many applications. Fatigue resistance generally relates to the ability to resist the local deformation of materials caused by repeated stresses. The behavior of materials subjected to repeated cyclic loading in terms of flexing, stretching, compressing, or twisting is generally described as fatigue. Such repeated cyclic loading eventually constitutes a mechanical deterioration and progressive fracture that leads to complete failure. Fatigue life generally relates to the number of cycles of deformation required to bring about the failure of the test specimen under a given set of oscillating conditions.

The failure of a component when subjected to repeated application of stress or strain limits the range of applicability of certain thermoplastic materials. These and other shortcomings of the prior art are addressed by the present disclosure.

### SUMMARY

Fatigue failure of component parts can lead to the catastrophic failure of equipment, directly impacting transportation, power generation, and mechanics of a device. For example, gears made from thermoplastic material are important elements in the power transmission systems of many high horsepower applications of modern machines. Such gears may be in the form of a wheel with teeth. Gears are exposed to repeated mechanical stresses which over time can lead to limited gear life. The gears may experience localized overloading causing inclusions, notches, or stiffness jumps (inner notches) that lead to material damage. This damage directly impacts the gear teeth. In the event of tooth breakage of the gear wheel, the power will not be transmitted properly among to interconnected gears.

Thus, it is useful for such parts to have higher fatigue resistance, over a wide range of temperatures, so that the parts may have a longer part-life.

Thus there is a need in the art to improve the fatigue life of thermoplastics materials used in molded parts, which in turn will expand the applicability of these materials.

Additionally, there is a need in the art to improve gear-life by avoiding tooth breakage. The breakage of a gear tooth results in malfunction of the equipment where the gear is used. It is therefore desirable to have gears with longer life.

In one aspect, the disclosure concerns compositions comprising: from about 40 wt. % to about 99.95 wt. % of a polymer base resin; from 0 wt. % to about 60 wt. % of a reinforcing filler; from 0 wt. % to about 25 wt. % of a lubricant; and from about 0.05 wt. % to about 10 wt. % of a cross-linking agent; wherein the composition is treated to induce cross-linking, wherein the combined weight percent value of all components does not exceed 100 wt %, the weight percentages are based on the total weight of the composition and wherein the composition shows improved tensile fatigue versus a corresponding composition without the cross-linking agent and not treated to induce cross-linking, used as control. In some embodiments, the composition exhibits a number of tensile fatigue cycles to failure, measured at least one of 23° C. and 150° C., a frequency of 5 Hz and a stress ratio of 0.1, that is at least 20% higher than the number of tensile fatigue cycles to failure exhibited by a control composition, corresponding to the untreated composition without the cross-linking agent, when measured under a stress that is at least one of 10% or 20% or 30% or 40% or 50% or 60% or 70% or 80% or 90% of the tensile strength of the control composition, the tensile strength measured according to ISO 527-1. In certain embodiments, the tensile fatigue cycles are measured at 23° C. under a stress that is 60% of the tensile strength of the control composition. In other embodiments, the tensile fatigue cycles are measured at 23° C. under a stress that is 70% of the tensile strength of the control composition. In some embodiments, the tensile fatigue cycles are measured at 150° C. under a stress that is 60% of the tensile strength of the control composition.

In another aspect, the disclosure concerns methods of preparing a composition comprising: (i) forming a mixture of from about 40 wt. % to about 99.95 wt. % of a polymer base resin; from 0 wt. % to about 60 wt. % of a reinforcing filler; from about 2.5 wt. % to about 25 wt. % of a lubricant; and from about 0.05 wt. % to about 10 wt. % of a cross-linking agent; (ii) inducing cross-linking in the mixture to form the composition; wherein the combined weight percent value of all components does not exceed 100 wt %.

### DETAILED DESCRIPTION OF ILLUSTRATIVE EMBODIMENTS

In certain aspects, the disclosure concerns compositions comprising: (i) from about 40 wt. % to about 99.95 wt. % of a polymer base resin; (ii) from 0 wt. % to about 60 wt. % of a reinforcing filler; (iii) from 0 wt. % to about 25 wt. % of a lubricant; and (iv) from about 0.05 wt. % to about 10 wt. % of a cross-linking agent; wherein the composition is treated to induce cross-linking The compositions exhibit good tensile fatigue-at least 20% higher than a corresponding control composition (i.e. untreated without cross-linker), when measured at 23° C., under a stress of 50% of the tensile strength of the control composition, a stress ratio of 0.1, and a frequency of 5 Hz. In some embodiments, the improvement is 50%, 60%, 100%, 1000%, 2000% or 5000% higher than a corresponding composition without cross-linker. In certain embodiments, the above cited improvement versus the control composition is seen at a temperature of 150° C. In certain embodiments, the composition does not break in at least 1,000,000 cycles at 23° C. under a stress of 40, 60, 80 or 100 MPa, a stress ratio of 0.1, and a frequency of 5 Hz in some embodiments. In addition, the disclosure concerns articles (including those where good fatigue resistance is beneficial) and methods for making such compositions and articles.

### Polymer Base Resin

Any suitable polymer base resin may be utilized. Preferred resins include polyamide, polyolefin, polyester, polycarbonate, poly(p-phenylene oxide), polyetherimide, polyetherketone, Polyphenylene ether, or any of the aforementioned resins comprising a co-monomer which contains at least one acetylenic moiety, or a combination thereof. Compositions disclosed herein comprise about 40 to about 99.95 weight percent base polymer. In some embodiments, the compositions comprise about 40 to about 95 or about 40 to about 80 weight percent or about 50 to about 75 weight percent base polymer resin.

### Polyamide

Polyamides are generally produced by polymerization of a polyamine and a dicarboxylic acid (or analogous acid chloride). Some suitable polyamides can be polymerized from aliphatic dicarboxylic acids having from 4 to 12 carbon atoms and aliphatic diamines having from 2 to 12 carbon atoms. In some embodiments, Preferred aliphatic diamines are represented by the formula H₂N—(CH₂)ₙ—NH₂ where n is about 2 to about 12. One highly preferred aliphatic diamine is hexamethylenediamine (H₂N—(CH₂)₆—NH₂). It is preferred that the molar ratio of the dicarboxylic acid to the diamine be about 0.66 to about 1.5. Within this range it is generally desirable to have the molar ratio be greater than or equal to about 0.81, preferably greater than or equal to about 0.96. Also desirable within this range is an amount of less than or equal to about 1.22, preferably less than or equal to about 1.04. Preferred polyamides include nylon-6, nylon-6,6, nylon-4,6, nylon-6, 12, nylon-10, and the like, or combinations including at least one of the foregoing nylons.

The polyamides can also be semi-aromatic polyamides, such as PA4.T, PA6.T, or PA9.T polyamides. As used herein, a “semi-aromatic polyamide” is understood to be a polyamide homo- or copolymer that contains aromatic or semi-aromatic units derived from an aromatic dicarboxylic acid, an aromatic diamine, or an aromatic aminocarboxylic acid, the content of said units being at least 50 mol %. In some cases these semi-aromatic polyamides are blended with small amounts of aliphatic polyamides for better processability. They are available commercially, from e.g., DuPont, Wilmington, Del., USA under the Tradename Zytel HTN; Solvay Advanced Polymers under the Tradename Amodel; or from DSM, Sittard, The Netherlands under the Tradename Stanyl For Tii.

Polyamides may be made by methods well known to those skilled in the art.

### Polyolefin

Polyolefins comprise a class of organic compounds having the general structure C₁H₂ₙ and may be unmodified, or non-functionalized. As used herein, “polyolefin” may refer to polyolefin resins which are polymerized with an olefin monomer such as propylene, ethylene or butene and can be selected according to the required performance of a product such as heat resistance, flexibility and transparency. The polyolefin elastomer polymer can be used alone or in admixture of a plurality of polyolefin resins in consideration of their crystallinity, noncrystallinity and elasticity.

Exemplary polyolefin resins can include, but are not limited to, polypropylene homopolymers such as isotactic polypropylene, syndiotactic polypropylene and atactic polypropylene, polyethylene resins, propylene α-olefin copolymers or ethylene α-olefin copolymers having at least one α-olefin monomer such as ethylene, propylene, butene, pentene, hexene, heptene, octene or 4-methylpentene-1, ethylene vinylacetate copolymers, ethylene vinylalcohol copolymers, ethylene acrylic acid copolymers, cyclic polyolefin resins such as those made from pentadiene and/or derivatives, and the like.

Exemplary polyolefins can also include polypropylene homopolymers such as isotactic polypropylene, syndiotactic polypropylene and atactic polypropylene, polyethylene resins, isotactic polystyrene, syndiotactic polystyrene and atactic polystyrene propylene α-olefin copolymers or ethylene α-olefin copolymers having at least one α-olefin monomer such as ethylene, propylene, butene, pentene, hexene, heptene, octene or 4-methylpentene-1, ethylene vinylacetate copolymers, ethylene vinylalcohol copolymers, ethylene acrylic acid copolymers, cyclic polyolefin resins such as those made from pentadiene and/or derivatives, and the like.

In various aspects, the polyolefins used can include conventional low density polyethylene (LDPE) made under high pressure; LDPE copolymers incorporating other α-olefins polyethylene/vinyl acetate copolymers; linear low density polyethylenes (LLDPE), which include copolymers of ethylene with one or more of propylene, butene, hexene, 4-methyl pentene-1, octene-1, and other unsaturated aliphatic hydrocarbons. In one aspect, the α-olefins are propylene, butene-1, hexene-1,4-methylpentene-1 and octene-1.

Substantially linear ethylene polymer or one or more linear ethylene polymer (S/LEP), or a mixture thereof, can be useful in the disclosed thermoplastic compositions. Both substantially linear ethylene polymers and linear ethylene polymers are known. Substantially linear ethylene polymers and their method of preparation are fully described in U.S. Pat. No. 5,272,236 and U.S. Pat. No. 5,278,272. Linear ethylene polymers and their method of preparation are fully disclosed in U.S. Pat. No. 3,645,992; U.S. Pat. No. 4,937,299; U.S. Pat. No. 4,701,432; U.S. Pat. No. 4,937,301; U.S. Pat. No. 4,935,397; U.S. Pat. No. 5,055,438; EP 129,368; EP 260,999; and WO 90/07526. Such polymers are available commercially under the trade names ENGAGE™ polyolefin elastomers and AFFINITY™ polyolefin plastomers from The Dow Chemical Company, EXACT™ polyolefin elastomers from ExxonMobil, and TAFMER™ polyolefin elastomers from Mitsui.

### Polyester

Polyester polymers are generally obtained through the condensation or ester interchange polymerization of the polymer precursors such as diol or diol chemical equivalent component with the diacid or diacid chemical equivalent component and having recurring units of the formula (I):

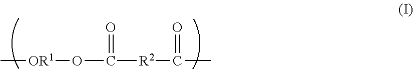

wherein R¹ represents an alkyl or cycloalkyl radical containing 2 to 12 carbon atoms and which is the residue of a straight chain, branched, or cycloaliphatic alkane diol having 2 to 12 carbon atoms or chemical equivalents thereof; and R² is an alkyl or a cycloaliphatic radical which is the decarboxylated residue derived from a diacid, with the proviso that at least one of R¹ or R² is a cycloalkyl group.

One preferred cycloaliphatic polyester is poly(1,4-cyclohexane-dimethano1-1,4-cyclohexanedicarboxylate) having recurring units of formula (II)

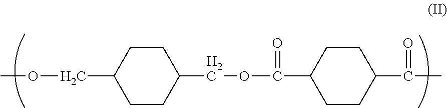

wherein in the formula (I), R¹ is a cyclohexane ring, and wherein R² is a cyclohexane ring derived from cyclohexanedicarboxylate or a chemical equivalent thereof and is selected from the cis- or trans-isomer or a mixture of cis- and trans-isomers thereof. Cycloaliphatic polyester polymers can be generally made in the presence of a suitable catalyst such as a tetra(2-ethyl hexyl)titanate, in a suitable amount, typically about 50 to 400 ppm of titanium based upon the total weight of the final product. Poly(1,4-cyclohexanedimethano1-1,4-cyclohexanedicarboxylate) generally forms a suitable blend with the polycarbonate. Aromatic polyesters or polyarylates can also be used in the compositions.

Preferably, the number average molecular weight of the copolyestercarbonates or the polyesters is about 3,000 to about 1,000,000 g/mole. Within this range, it is desirable to have a number average molecular weight of greater than or equal to about 10,000, preferably greater than or equal to about 20,000, and more preferably greater than or equal to about 25,000 g/mole. Also desirable is a number average molecular weight of less than or equal to about 100,000, preferably less than or equal to about 75,000, more preferably less than or equal to about 50,000, and most preferably less than or equal to about 35, 000 g/mole.

### Polycarbonate

The terms “polycarbonate” or “polycarbonates” as used herein includes copolycarbonates, homopolycarbonates and (co)polyester carbonates.

The term polycarbonate can be further defined as compositions have repeating structural units of the formula (1):

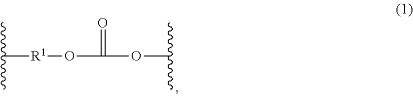

in which at least 60 percent of the total number of R¹ groups are aromatic organic radicals and the balance thereof are aliphatic, alicyclic, or aromatic radicals. In a further aspect, each R¹ is an aromatic organic radical and, more preferably, a radical of the formula (2):
wherein each of A¹ and A² is a monocyclic divalent aryl radical and Y¹ is a bridging radical having one or two atoms that separate A¹ from A². In various aspects, one atom separates A¹ from A². For example, radicals of this type include, but are not limited to, radicals such as —O—, —S—, —S(O)—, —S(O₂)—, —C(O)—, methylene, cyclohexyl-methylene, 2-└2.2.1┘-bicycloheptylidene, ethylidene, isopropylidene, neopentylidene, cyclohexylidene, cyclopentadecylidene, cyclododecylidene, and adamantylidene. The bridging radical Y¹ is preferably a hydrocarbon group or a saturated hydrocarbon group such as methylene, cyclohexylidene, or isopropylidene. Polycarbonate materials include materials disclosed and described in U.S. Pat. No. 7,786,246, which is hereby incorporated by reference in its entirety for the specific purpose of disclosing various polycarbonate compositions and methods for manufacture of the same.

### Polyether Ketone

The terms “polyetherketone” and “polyether ketone” refer to a polymer where aromatic rings within the polymer chain are linked by ether and ketone linkages. Exemplary polyolefin resins include, but are not limited to, aromatic polyether ketone (PEK), aromatic poly ether ether ketone (PEEK), aromatic polyether ketone ketone (PEKK) and poly ether ketone ether ketone ketone (PEKEKK). In some embodiments, polyether ketones are used in conjunction with thermal cross-linking products and processes.

### Polyphenylene Ether (PPE)

Polyphenylene ether (PPE), also known as poly(p-phenylene oxide) (PPO), is a polymer of the formula (3) and is commercially available from SABIC. PPE may be used in blends with other polymer such as polystyrene, high impact styrene-butadiene copolymer or polyamides, polypropylene or other polyolefins. One suitable blend is Flexible Noryl™ marketed by SABIC which is a PPO/thermoplastic elastomer (TPE) blend. Thermoplastic elastomers include styrenic block copolymers, polyolefin blends, elastomeric polyamides, thermoplastic polyurethanes and thermoplastic copolyester. Such polymers are known to those skilled in the art.

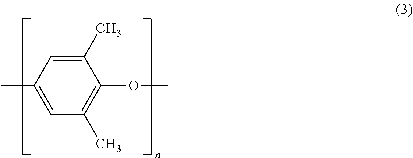

### Reinforcing Filler

Any suitable reinforcing filler may be utilized in the instant compositions. Reinforcing fibers include glass fiber, aramid fiber (including poly-para-phenylene terephthalamide fiber which is marketed by E.I. du Pont de Nemours under the name Kevlar®), carbon fiber (including standard carbon fiber, a performance carbon fiber, a long carbon fiber and graphite fiber), and plastic fiber. Other fillers include carbon nanotubes and other carbon nano structures. Reinforcing filler, such as carbon nanotubes, carbon nano structures, graphene, and similar types of nano-filler, can improve modulus of the compositions. Compositions disclosed herein comprise about 0.0 to about 60 weight percent reinforcing fiber. In some embodiments, the compositions comprise about 5 to about 45 or about 10 to about 50 weight percent or about 25 to about 35 weight percent reinforcing fiber.

### Lubricant

A wide range of lubricants may be used in the disclosed compositions. Preferred lubricants include thermal lubricants for thermoplastics. In some embodiments, suitable lubricants include polytetrafluoroethylene (PTFE) and PTFE copolymers, silicone resin modifier, molybdenum disulfide, aramid fibers, graphite and combination of them. Compositions disclosed herein comprise 0 to about 25 wt % lubricant. Some compositions comprise about 2.5 to about 25 weight percent lubricant. In some embodiments, the compositions comprise about 5 to about 25 or about 10 to about 20 weight percent or about 12 to about 18 weight percent lubricant.

### Cross-linking Agent

Cross-linking agents comprise a plurality of cross-linkable groups. In some embodiments, two, three, four or more reactive groups are found. In some embodiments, unsaturated alkyl groups such as alkenes, allylic, acrylate or methacrylate or maleimide groups are used as functional groups. Accordingly, in one embodiment a cross linking agent comprises at least one such functional group of which the structure may be presented by formula (4), where in R is an acrylate, a methacrylate group, an alkyl group or “H” and X is “C” or “O”. According to one preferred embodiment, the crosslinking agent may be a compound according to formula (5), where R is “H” or an alkyl group. One preferred cross-liking agent is triallyl isocyanurate (6). Other crosslinking agents include trimethallyl isocyanurate (7) and triallyl cyanurate (8) where R is an allyl group.

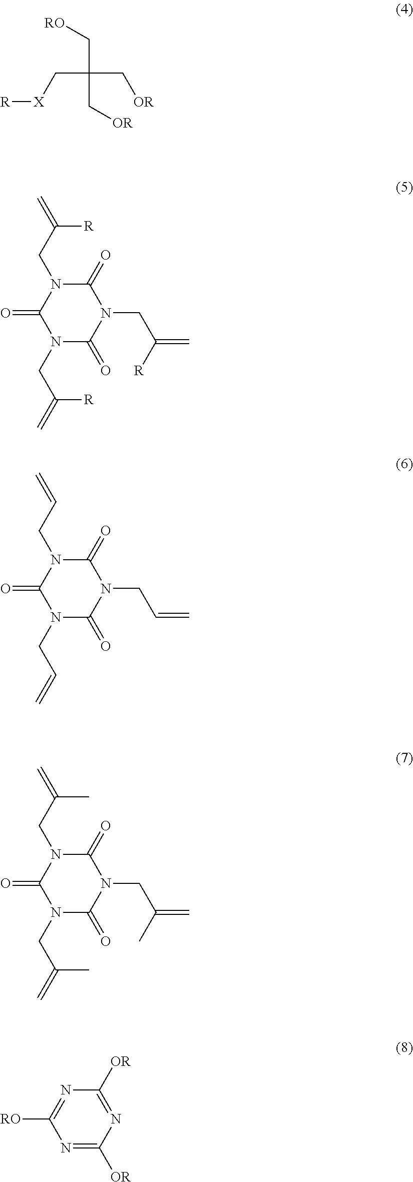

Cross-linking agents may also comprise acetylenic compounds, that is compounds having at least one carbon-carbon triple bond. In some embodiments, such compounds may be added as co-monomer to the polymerization reaction to obtain a cross-linkable acetylenic resin. The crosslinking agent can be incorporated into the polymer base resin as end-capping, as pendant group or as group inside the polymer chain or a combination thereof. In some embodiments, the cross-linking agent may be added as additive. In some embodiments, the cross-linking agent might be added as a combination of additive and co-monomer. The acetylenic compounds can be illustrated by acetylenic compounds of Formula (9) trough Formula (16)

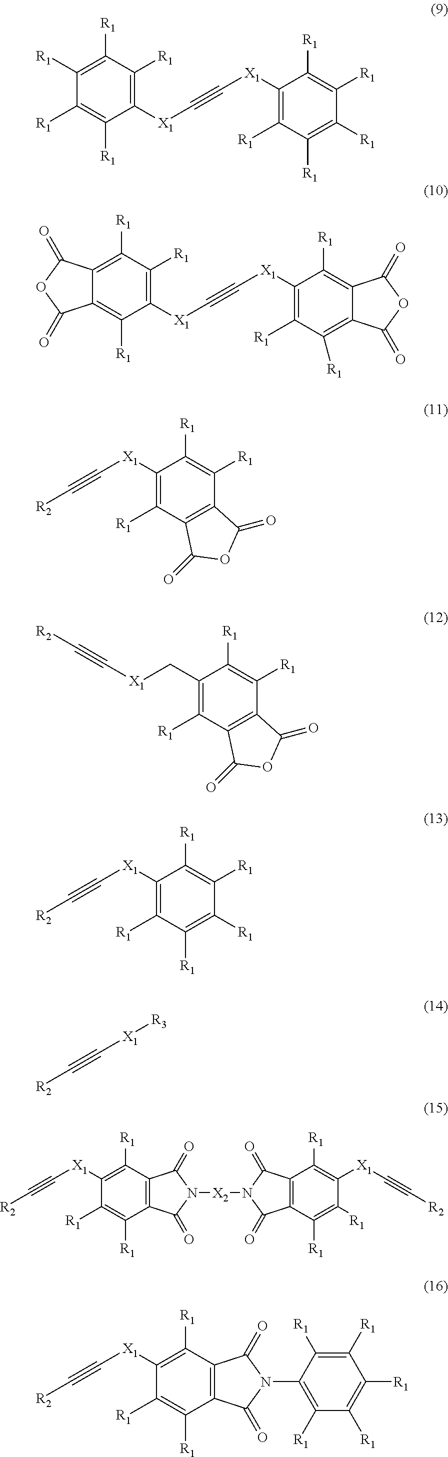

wherein R₁ is, independently from each other, selected from the group consisting of hydrogen (H), halogen (such as F, Cl, Br, I), a hydroxyl (OH), a cyano (CN), a carboxylic acid (CO(O)H), an ester (CO(O)A), wherein A is an akyl, alkenyl, alkynyl or allyl group, an ether, including cyclic ether and glycidyl ethers, or a acyl chloride. R₂ is, independently from each other, selected from the group consisting of hydrogen (H), alkyl group, such as, but not limited to, CH₃, CH₂CH₃, CH(CH)₂, C(CH₃)₃, an aromatic group (such as, but not limited to, phenyl, naphthyl, anthracenyl) or a halogen (such as F, Cl, Br, I). R₃ is, independently from each other, selected from the group consisting of hydrogen (H), a functional aromatic group (such as, but not limited to, 1,8-napthalicanhydride, 1,8-naphthalene-dicarboxylic acid, naphthalene-carboxylic acid, 9-anthracenecarboxylic acid. X₁ is a direct bond, a methylene (—CH₂), and ether (—O—), a carbonyl (—C(═O)—) or a sulfonyl (—S(═O)₂—) group. X₂ is an alkyl group (such as, but not limited to, CH₂)ₙ with n between 1-22) an aromatic group (such as, but not limited to, diphenyl ether or dibenzophenone).

In some embodiments a plurality of crosslinking molecules are used as crosslinking agent. One molecule is sometimes referred as the crosslinker and the other molecules are sometimes called the booster(s). Boosters typically contain one or more acetylenic and/or alkyne carbon bonds. Examples of booster include compounds 15 and 16 depicted above.

Compositions disclosed herein comprise about 0.05 to about 10 weight percent cross-liking agent or 0.05 to about 6 weight percent cross-liking agent. In some embodiments, the compositions comprise about 1 to about 5 or about 2 to about 4 weight percent weight percent cross-linking agent. Boosters may be included in the amount of cross-linking agent.

### Polymer Composition and Extrusion

Some compositions comprise polymer derived from melt extrusion of from about 45 wt. % to about 99.95 wt. % of a polymer base resin; from about 0.0 wt. % to about 50 wt. % of a reinforcing filler; from about 2.5 wt. % to about 25 wt. % of a lubricant; and from about 0.05 wt. % to about 10 wt. % of a cross-linking agent; wherein the composition is treated to induce cross-linking

The polymer compositions may additionally contain additives as described herein.

The polymer compositions can be formed by techniques known to those skilled in the art. Extrusion and mixing techniques, for example, may be utilized to combine the components of the polymer composition.

In certain embodiments, extruding is performed using an extruder such as a twin screw extruder by techniques known to those skilled in the art.

### Cross-Linking

Cross-linking may be performed by techniques known to those skilled in the art. Some techniques use heat to drive the formation of cross-links In certain embodiments, cross-linking is accomplished by heating the mixture or molded part at a temperature range from about 80° C. to about 400° C. or about 160° C. to about 400° C. for a time of from about 2 min to about 7 days or about 10 min to about 3 days. In some embodiments, heat initiated cross-linking is initiated upon and/or subsequent to molding.

Other cross-linking techniques include exposure to high energy radiation such as beta or gamma or x-ray radiation. Some irradiation methods use multiple exposures to irradiation. For example, one method uses 4 passes through an irradiation apparatus where irradiation is increased from 25 kGy to 100 kGy during the series of passes. Other numbers of passes may be used as appropriate for the process.

### Articles of Manufacture

In one aspect, the present disclosure pertains to shaped, formed, or molded articles comprising the compositions described herein. The compositions can be molded into useful shaped articles by a variety of means such as injection molding, extrusion, rotational molding, blow molding and thermoforming to form articles. The compositions described herein can also be made into film and sheet as well as components of laminate systems. In a further aspect, a method of manufacturing an article comprises melt blending the components; and molding the extruded composition into an article. In a still further aspect, the extruding is done with a twin-screw extruder.

In a further aspect, the article comprising the disclosed copolymer compositions are particularly suitable for use in articles where fatigue resistance is important. Gears are one such end use. Other examples of articles include, but are not limited to, tubing, hinges, parts on vibrating machinery, and pressure vessels under cyclic pressures.

### Aspects

The present disclosure comprises at least the following aspects.

Aspect 1. A composition comprising:
from about 40 wt. % to about 99.95 wt. % of a polymer base resin;
from 0 wt. % to about 60 wt. % of a reinforcing filler;
from 0 wt. % to about 25 wt. % of a lubricant; and
from about 0.05 wt. % to about 10 wt. % of a cross-linking agent;
wherein the composition is treated to induce cross-linking;

wherein the composition exhibits a number of tensile fatigue cycles to failure, measured at 23° C., a frequency of 5 Hz and a stress ratio of 0.1, that is at least 20% higher than the number of tensile fatigue cycles to failure exhibited by a control composition, corresponding to the untreated composition without the cross-linking agent, when measured under a stress that is at least one of 10% or 20% or 30% or 40% or 50% or 60% or 70% or 80% or 90% of the tensile strength of the control composition, the tensile strength measured according to ISO 527-1; and

wherein the combined weight percent value of all components does not exceed 100 wt %, and wherein all weight percent values are based on the total weight of the composition.

Aspect 2. A composition comprising:
from about 40 wt. % to about 99.95 wt. % of a polymer base resin;
from 0 wt. % to about 60 wt. % of a reinforcing filler;
from 0 wt. % to about 25 wt. % of a lubricant; and
from about 0.05 wt. % to about 10 wt. % of a cross-linking agent;
wherein the composition is treated to induce cross-linking;

wherein the composition exhibits a number of tensile fatigue cycles to failure, measured at 23° C., a frequency of 5 Hz and a stress ratio of 0.1, that is at least 20% higher than the number of tensile fatigue cycles to failure exhibited by a control composition, corresponding to the untreated composition without the cross-linking agent, when measured under a stress that is at least one of 10% or 20% or 30% or 40% or 50% or 60% or 70% or 80% or 90% of the tensile strength of the control composition, the tensile strength measured according to ISO 527-1; and wherein all weight percent values are based on the total weight of the composition,

wherein the control composition consists essentially of from about 40 wt. % to about 100 wt. % of a polymer base resin; from 0 wt. % to about 60 wt. % of a reinforcing filler; from 0 wt. % to about 25 wt. % of a lubricant; and is substantially free of cross-linking agent; and wherein the combined weight percent value of all components does not exceed 100 wt %.

Aspect 3. The composition of Aspect 1 or Aspect 2 comprising:
from about 40 wt. % to about 79 wt. % of a polymer base resin;
from about 10 wt. % to about 50 wt. % of a reinforcing filler;
from about 10 wt. % to about 20 wt. % of a lubricant; and
from about 1 wt. % to about 5 wt. % of a cross-linking agent.

Aspect 4. The composition of any one of Aspects 1-3, wherein the composition exhibits a number of tensile fatigue cycles to failure measured at 150° C., a frequency of 5 Hz and a stress ratio of 0.1 that is at least 20% higher than the number of tensile fatigue cycles to failure exhibited by a control composition, corresponding to an untreated composition without the cross-linking agent, when measured under a stress that is 60% of the tensile strength of the composition, the tensile strength measured according to ISO 527-1 at 150° C.

Aspect 5. The composition of any one of Aspects 1-3, wherein the composition exhibits a number of tensile fatigue cycles to failure, measured at 23° C., a frequency of 5 Hz and a stress ratio of 0.1, that is at least 20% higher than that exhibited by a corresponding composition without the cross-linking agent (control composition) when measured under a stress that is 60% of the tensile strength of the control composition, the tensile strength measured according to ISO 527-1 at 23° C.

Aspect 6. The composition of any one of Aspects 1-5, wherein the polymer base resin comprises polyamide, polyolefin, polyester, polycarbonate, poly(p-phenylene oxide), polyetherimide, polyetherketone, or any of the aforementioned resins comprising a co-monomer which comprises at least one acetylenic moiety, or a combination thereof.

Aspect 7. The composition of any one of Aspects 1-6, wherein the cross-linking agent comprises a plurality of alkene, allylic acrylate or methacrylate or maleimide groups or combination thereof.

Aspect 8. The composition of any one of Aspects 1-6, wherein the cross-linking agent comprises a compound according to formula (4)-(8) or a combination thereof.

Aspect 9. The composition of any one of Aspects 1-6, wherein the cross-linking agent comprises a moiety having at least one carbon-carbon triple bond.

Aspect 10. The composition of any one of Aspects 1-6, wherein the cross-linking agent comprises a compound according to formula (9)-(16) or a combination thereof.

Aspect 11. The composition of any one of Aspects 1-10, wherein the lubricant comprises polytetrafluoroethylene or aramid fiber or silicon oil or graphite or silicon oil or wax or polyolefin or combination thereof.

Aspect 12. The composition of any one of Aspects 1-11, wherein the reinforcing fiber comprises glass or carbon fiber or carbon nanotubes or carbon nano structures or graphene or combination thereof.

Aspect 13. The composition of any one of Aspects 1-12, wherein inducing cross-linking comprises irradiation of the mixture.

Aspect 14. The composition of any one of Aspects 1-12, wherein inducing cross-linking comprises heating of the mixture

Aspect 15. The composition of Aspect 13, wherein the irradiation is performed using gamma or beta or x-ray radiation or combination thereof.

Aspect 16. The composition of Aspect 15, wherein the radiation dose is 25 to 400 kGy.

Aspect 17. The composition of Aspect 14, wherein the heating is at a temperature from 80° C. to 400° C. and a time from 2 min to 7 days.

Aspect 18. The composition of any one of Aspects 1-17, wherein the reinforcing filler is present in an amount of between 0-30 wt %.

Aspect 19. The composition of any one of Aspects 1-17, wherein the reinforcing filler is present in an amount of between 5-15 wt %.

Aspect 20. An article comprising a composition of any one of Aspects 1-19.

Aspect 21. The article of Aspect 20, wherein the article is a gear.

Aspect 22. A method of preparing a composition comprising: forming a mixture of from about 40 wt. % to about 99.95 wt. % of a polymer base resin; from 0 wt. % to about 60 wt. % of a reinforcing filler; from 0 wt. % to about 25 wt. % of a lubricant; and from about 0.05 wt. % to about l0wt. % of a cross-linking agent; and

inducing cross-linking in the mixture to form the composition,

wherein the composition exhibits a number of tensile fatigue cycles to failure, measured at at least one of 23° C. and 150° C., a frequency of 5 Hz and a stress ratio of 0.1, that is at least 20% higher than the number of tensile fatigue cycles to failure exhibited by a control composition, corresponding to the untreated composition without the cross-linking agent, when measured under a stress that is at least one of 10% or 20% or 30% or 40% or 50% or 60% or 70% or 80% or 90% of the tensile strength of the control composition, the tensile strength measured according to ISO 527-1; and

wherein the combined weight percent value of all components does not exceed 100 wt % and wherein all weight percent values are based on the total weight of the composition.

Aspect 23. A method of preparing a composition comprising: forming a mixture of from about 40 wt. % to about 99.95 wt. % of a polymer base resin; from 0 wt. % to about 60 wt. % of a reinforcing filler; from 0 wt. % to about 25 wt. % of a lubricant; and from about 0.05 wt. % to about l0wt. % of a cross-linking agent; and inducing cross-linking in the mixture to form the composition,

wherein the composition exhibits a number of tensile fatigue cycles to failure, measured at at least one of 23° C. and 150° C., a frequency of 5 Hz and a stress ratio of 0.1, that is at least 20% higher than the number of tensile fatigue cycles to failure exhibited by a control composition, corresponding to the untreated composition without the cross-linking agent, when measured under a stress that is at least one of 10% or 20% or 30% or 40% or 50% or 60% or 70% or 80% or 90% of the tensile strength of the control composition, the tensile strength measured according to ISO 527-1;

wherein the control composition consists essentially of from about 40 wt. % to about 100 wt. % of a polymer base resin; from 0 wt. % to about 60 wt. % of a reinforcing filler; from 0 wt. % to about 25 wt. % of a lubricant; and is substantially free of cross-linking agent; and

wherein the combined weight percent value of all components does not exceed 100 wt % and wherein all weight percent values are based on the total weight of the composition;

Aspect 24. The method of Aspect 22 or Aspect 23 comprising:
from about 45 wt. % to about 79 wt. % of a polymer base resin;
from about 10 wt. % to about 50 wt. % of a reinforcing filler;
from about 10 wt. % to about 20 wt. % of a lubricant; and
from about 1 wt. % to about 5 wt. % of a cross-linking agent.

Aspect 25. The method of any one of Aspects 22-24, wherein the composition exhibits a number of tensile fatigue cycles to failure measured at 150° C., a frequency of 5 Hz and a stress ratio of 0.1 that is at least 20% higher than the number of tensile fatigue cycles to failure exhibited by a control composition, corresponding to an untreated composition without the cross-linking agent, when measured under a stress that is 60% of the tensile strength of the composition, the tensile strength measured according to ISO 527-1 at 150° C.

Aspect 26. The method of any one of Aspects 22-25, the polymer base resin comprises polyamide, polyolefin, polyester, polycarbonate, polyetherimide, poly(p-phenylene oxide), polyetherketone, or any of the aforementioned resins comprising a co-monomer which comprises at least one acetylenic moiety, or a combination thereof.

Aspect 27. The method of any one of Aspects 22-26, wherein the cross-linking agent comprises a plurality of alkene, allylic acrylate or methacrylate or maleimide groups or combination of thereof.

Aspect 28. The method of any one of the Aspects 22-26, wherein the cross-linking agent comprises a compound according to formula (4)-(8) or a combination thereof.

Aspect 29. The method of any one of Aspects 22-26, wherein the cross-linking agent comprises a moiety having a moiety having at least one carbon-carbon triple bond.

Aspect 30. The method of any one of Aspects 22-26, wherein the cross-linking agent comprises a compound according to formula (9)-(16) or a combination thereof.

Aspect 31. The method of any one of Aspects 22-30, wherein the lubricant comprises polytetrafluoroethylene or aramid fiber or silicon oil or graphite or silicon oil or wax or polyolefin or combination thereof.

Aspect 32. The method of any one of Aspects 22-31, wherein the reinforcing fiber comprises glass or carbon fiber or combination thereof.

Aspect 33. The method of any one of Aspects 22-32, wherein the composition exhibits a number of tensile fatigue cycles to failure, measured at 23° C., a frequency of 5 Hz and a stress ratio of 0.1, that is at least 40% higher than the number of tensile fatigue cycles to failure exhibited by a control composition, corresponding to the untreated composition without the cross-linking agent, when measured under a stress that is 60% of the tensile strength of the control composition, the tensile strength measured according to ISO 527-1.

Aspect 34. The method of any one of Aspects 22-33, wherein inducing cross-linking comprises irradiation of the mixture.

Aspect 35. The method of any one of Aspects 22-33, wherein inducing cross-linking comprises heating of the mixture or molded part

Aspect 36. The method of Aspect 34, wherein the irradiation is performed using gamma or beta or x-ray radiation or combination thereof.

Aspect 37. The method of Aspect 36, wherein the radiation dose is 25 to 400 kGy.

Aspect 38. The method of Aspect 35, wherein the heating is 80° C. to 400° C. and 2 min to 7 days.

### EXAMPLES

The disclosure is illustrated by the following non-limiting examples.

Fatigue data are generally reported as the number of cycles to fail at a given stress level.

Fatigue resistance data is of practical importance in the design of articles and parts which will undergo repetitive cyclic loading.

In order to compare different materials we selected at least one stress level and compared the number of cycles to failure. The material with the lager number of cycles to failure, measured in same stress and other testing conditions, has the better fatigue performance.

### Tensile Fatigue Testing Procedure

When “tensile fatigue” results are referenced herein, they refer to the testing method that follows. The fatigue test is done in an environment of 23±2° C., 50±5% relative humidity (RH), unless otherwise specified.

The following Universal Testing Machines (a) MTS 858 and (b) Instron 8874.

The following definitions are used in the testing.

Stress is determined by the equation σ=P/A where a is the stress, P is the load on the sample and A is the area of cross section in the test area.

Peak stress is the maximum stress applied on the sample during a load cycle.

Stress ratio is the ratio of the minimum and maximum stress during a load cycle.

Mean stress is the average value of maximum and minimum stresses in a load cycle. This is also known as the set point in machine operating manuals.

Specimen size (mm) is shown in the table below.

| Tensile test bar | ISO 527, Type 1A | ASTM D638, Type-I | |
|---|---|---|---|
| Overall length | ≥150 | ≥165 | (6.5″) |
| Length of parallel portion | 80 ± 2 | 57 | (2.25″) |
| Radius of fillet | 20 to 25 | 76 | (3″) |
| Width at ends | 20 ± 0.2 | ≥19 | (0.75″) |
| Width at narrow portion | 10 ± 0.2 | 13 | (0.05″) |
| Thickness | 4 ± 0.2 | 3.2 ± 0.4 | |
| Distance between grips | 115 ± 1 | 115 | (4.5″) |

Before the commencement of the test, the samples are conditioned at 23±2° C. and 50±5% RH for 48 hrs (ISO 291/ASTM 618).

Test Parametres are as Follows:

### Test Frequency:

The test is load-controlled, the load being varied in a sinusoidal waveform between 100% and 10% of the nominal stress level. The default test frequency is 5 Hz.

### Stress Ratio:

The ratio of the minimum and maximum stresses in a load cycle. The default value of stress ratio is 0.1, unless mentioned otherwise.

A standard tensile test may be carried out to determine the appropriate stress levels for the fatigue test. The stress level to test fatigue is selected within the elastic range of the material at a given temperature. The failure criterion may be taken as specimen rupture.

The fatigue test may be done at elevated temperature with the help of an environmental chamber attached to the UTM. Samples are conditioned for 60 to 90 minutes at the test temperature immediately before starting the test.

The following results are noted in the output reports: Sample ID, Test temperature, ° C., Frequency of testing, Hz, Stress levels, MPa, and corresponding number of cycles to failure.

In the following examples tensile fatigue life has been measured using (ISO) tensile bars. Stress ration of 0.1 and a frequency of 5 Hz was used. All specimens were conditioned for 48 hrs, at 23° C. and 50% relative humidity before testing. The specimens that reached 1 million cycles did not show any failure and the test was stopped.

Pellets of a length of 3 mm (+/1 0.2 mm) were compounded with a 25 mm twin screw extruder where polymer, reinforcing fiber, and other ingredients were mixed. The detailed compositions are given in tables 1, 5, 7, 10, 13, 16, 19, 21, 24, 27, 30, 31 and 35, all values in the mentioned tables are reported as weight percent (wt %) of the composition, wherein the combined weight percent value of all components does not exceed 100 wt %, the weight percentages are based on the total weight of the composition. Tensile fatigue life has been measured using (ISO) tensile bars. Results are given in the Tables 3, 4, 6, 8, 9, 11, 12, 14, 15, 17, 18, 20, 22, 23, 25, 26, 28, 29, 32, 33, 34, 36, 37, 38, 39 and 40. In these tables, the number of cycles to failure observed using tensile fatigue on ISO tensile bars at 23 or 150° C. is shown. Stress ration of 0.1 and a frequency of 5 Hz was used. All specimens were conditioned for 48 hrs, at 23° C. and 50% relative humidity before testing. The specimens that reached 1 million cycles did not show any failure and the test was stopped

### Example 1

TABLE 1

| | | Sample 1 | |
|---|---|---|---|
| Component | Chemical Name (Description) | Control | Sample 2 |
| Polymer | Polyamide-6,6 | 54.90 | 49.40 |
| Stabilizer | N,N′-hexane-1,6-diylbis(3- | 0.05 | 0.05 |
| | (3,5-di-tert-butyl-4- | | |
| | hydroxyphenylpropionamide | | |
| Stabilizer | (Tris(2,4-ditert- | 0.05 | 0.05 |
| | butylphenyl)phosphite) | | |
| Lubricant | Polytetrafluoroethylene powder | 15.00 | 15.00 |
| Crosslinker | Masterbatch of 60 wt % triallyl | 0.00 | 5.50 |
| Masterbatch | isocyanurate in 40 wt % | | |
| | Polyamide-6 (Cross-linker) | | |
| Reinforcing | Chopped glass fiber | 30.00 | 30.00 |
| Fiber | | | |
| | Total (wt %) | 100 | 100 |

The two compositions made in Table 1 were tested and the results are shown in Table 2. Tensile specimens of Sample 2 were cross-linked by receiving a dose of 100 kGy using an e-beam source, in multiple passes (each one of 25 kGy). The tensile bars were contained in polyethylene plastic bags during exposure to the e-beam which was turned from one side to the other after each pass to allow a homogenous irradiation.

An indirect verification of the occurrence of the cross linking was seen by dynamic mechanical analyzer (DMA) by measuring storage modulus above 260° C. (melting temperature of polyamide-6,6), of tensile bar of the formulation of Sample 2 after exposure to a dose of 100 kGy and comparing it with the storage modulus of the control sample (Sample 1). Sample 1 does not contain cross-linker and has not been exposed to irradiation. The storage modulus of bars of Sample 2, exposed at 100 kGy of e-beam radiation, is 100 MPa or higher, at temperature between 270-285° C., while the DMA of control sample (Sample 1) showed a drop of storage modulus to 10 MPa, at temperature between 270-285° C., in line with the fact that polyamide-6,6 is above its melting temperature (Tₘ).

The mechanical properties have been measured at 23° C. and 150° C. for Samples 1 and 2. As expected the tensile properties measured at 150° C. for sample 2 are better than the Sample 1 control sample, due to the fact that the latter one is not cross-linked. The mechanical properties of Samples 1 and 2, measured at room temperature, are equivalent. The observed differences are within the variation of test. The only exception is the tensile strength (measured at 23° C.) which is higher for Sample 2.

TABLE 2

| | | | | | Sample 2 |
|---|---|---|---|---|---|
| Sample | | | | | (crosslinked |
| Temp (° C.) | Test description | Test Method | Unit | Sample 1 | 100 kGy) |
| 23 | Izod Impact Strength | ISO 180/1A | kJ/m2 | 13.2 | 11.0 |
| | Notched -AVG | | | | |
| 23 | Izod Impact Strength | | | 0.05 | 0.3 |
| | Notched - STD | | | | |
| 23 | Izod Impact Strength | ISO 180/1U | kJ/m2 | 71.9 | 66.8 |
| | Unnotched - AVG | | | | |
| 23 | Izod Impact Strength | | | 4.5 | 4.7 |
| | Unnotched - STD | | | | |
| 23 | Tensile Strength - AVG | ISO 527-1 | MPa | 160.0 | 174.8 |
| 23 | Tensile Strength - STD | | | 0.6 | 0.1 |
| 23 | Tensile Elongation -- | ISO 527-1 | % | 3.4 | 3.4 |
| | AVG | | | | |
| 23 | Tensile Elongation - STD | | | 0.0 | 0.1 |
| 23 | Tensile E modulus - | ISO 527-1 | GPa | 10.0 | 10.6 |
| | AVG | | | | |
| 23 | Tensile E modulus - STD | | | 0.2 | 0.1 |
| 150 | Tensile Strength -- AVG | ISO 527-1 | MPa | 66.7 | 80.7 |
| 150 | Tensile Strength - STD | | | 1.5 | 1.8 |
| 150 | Tensile Elongation -AVG | ISO 527-1 | % | 4.9 | 3.9 |
| 150 | Tensile Elongation - STD | | | 0.2 | 0.4 |
| 150 | Tensile E-modulus - | ISO 527-1 | GPa | 4.2 | 4.8 |
| | AVE | | | | |
| 150 | Tensile E-modulus -- | | | 0.3 | 0.0 |
| | STD | | | | |
| 23 | Flexural Strength - AVG | ISO 178 | MPa | 241.6 | 248.2 |
| 23 | Flexural Strength -- STD | | | 1.5 | 3.6 |
| 23 | Flexural Modulus - AVG | ISO 178 | GPa | 9.4 | 8.8 |
| 23 | Flexural Modulus - STD | | | 0.1 | 0.1 |

The Control Sample had a tensile strength of 160.0 MPa and Sample 2 had a tensile strength of 175 Mpa as measured by ISO 527-1. At a stress of 80 MPa, the measurement was at 50% of the tensile strength of the control sample. Similarly, at 90 MPa, the measurement was at 56% of the tensile strength of the control sample, at 95 MPa, the measurement was at 59% of the tensile strength of the control sample, at 100 MPa, the measurement was at 63% of the tensile strength of the control sample, at 110 MPa, the measurement was at 69% of the tensile strength of the control sample, and at 120 MPa, the measurement was at 75% of the tensile strength of the control sample.

TABLE 3

| | | Sample 1 | Sample 2 | |
|---|---|---|---|---|
| | | Dose | | |
| Test | | 0 kGy | 100 kGy | Change of |
| Temperature | | Number of | Number of | sample 2 |
| 23° C. | Stress, | Cycles to | Cycles to | vs. Control |
| Specimens | MPa | Failure | Failure | sample. 1 |
| 1 | 80 | 321,321 | 1,000,000 | |
| 2 | 80 | 300,860 | 1,000,000 | |
| 3 | 80 | 94,744 | 1,000,000 | |
| Average | | 238,975 | 1,000,000 | 318% |
| 1 | 90 | 22,363 | 1,000,000 | |
| 2 | 90 | 20,235 | 1,000,000 | |
| 3 | 90 | 6,514 | 1,000,000 | |
| 4 | 90 | 3,963 | | |
| Average | | 13,269 | 1,000,000 | 7,437% |
| 1 | 95 | 7,420 | 392,272 | |
| 2 | 95 | 6,758 | 567,000 | |
| 3 | 95 | 2,340 | 456,410 | |
| Average | | 5,506 | 471,894 | 8,471% |
| 1 | 100 | 3,051 | 244,537 | |
| 2 | 100 | 2,971 | 250,961 | |
| 3 | 100 | 1,449 | 44,699 | |
| 4 | 100 | 1,241 | 26,812 | |
| Average | | 2,178 | 141,752 | 6,408% |
| 1 | 110 | 966 | 2,055 | |
| 2 | 110 | 567 | 2,618 | |
| 3 | 110 | 472 | 2,649 | |
| Average | | 520 | 2441 | 369% |
| 1 | 120 | 348 | 830 | |
| 2 | 120 | 316 | 1045 | |
| Average | | 332 | 938 | 182% |

In Table 4, the number of cycles to failure observed during tensile fatigue on ISO tensile-bars at a temperature of 150° C. The tests use a stress ratio 0.1 and frequency 5 Hz. All specimens were conditioned for 48 hrs, at 23° C. and 50% relative humidity before testing. The specimens that reached 1 million cycles did not show any failure and the test was stopped.

In Table 4, the control sample had a tensile strength of 66.70 MPa and Sample 2 had a tensile strength of 80.7 MPa as measured by ISO 527-1. At a stress of 45 MPa, the measurement was at 67% of the tensile strength of the control sample. Similarly, at 50 MPa, the measurement was at 75% of the tensile strength of the control sample.

TABLE 4

| | |
|---|---|
| Sample 1 | |
| (control) | Sample 2 |

Dose

| Test | | 0 kGy | 100 kGy | Change of |
|---|---|---|---|---|
| Temperature | | Number of | Number of | samples 2 |
| 150° C. | Stress, | Cycles to | Cycles to | vs control |
| Sample No. | MPa | Failure | Failure | sample 1 |
| 1 | 45 | 28,257 | 1,000,000 | |
| 2 | 45 | 38,073 | 1,000,000 | |
| Average | | 33,165 | 1,000,000 | 2915 |
| 1 | 50 | 9,165 | 354,195 | |
| 2 | 50 | 13,318 | 341,617 | |
| Average | | 11,242 | 354,195 | 3050 |

From Tables 3 and 4, it can be seen that sample 2, crosslinked using a dose of 100 kGy, shows a number of cycles that is at least one order of magnitude higher than the control, for each stress value tested. It is remarkable that the improved fatigue life is showed over a wide range of temperature, i.e. at both 23 and 150° C. Moreover, at 80 and 90 MPa, (23° C.), specimens of sample 2 do not show breakage after 1 million cycle, while the control (sample 1) breaks at about 300-thousand and 20-thousand cycles respectively. Similar results are observed at 150° C., at a stress of 45 MPa, specimens of sample 2, which is cross-linked with a dose of 100 kGy, reach 1 million cycles with no breakage while the specimens of control sample (number 1) reach only about 33 thousand cycles.
From Table 3 it can be also seen that at values of stress 56, 59 and 63% of the tensile strength the average number of cycles of sample 2 is more than 6000% higher that the control (sample 1).

### Example 2

Additional compositions without filler were prepared and summarized in Table 5. Fatigue tests were performed and results reported in Table 6. In Table 6, the control sample had a tensile strength of 72 MPa and Sample 5 had a tensile strength of 81 MPa as measured by ISO 527-1. At a stress of 38 MPa, the measurement was at 53% of the tensile strength of the control sample. Similarly, at 42 MPa, the measurement was at 58% of the tensile strength of the control sample and at 46 MPa, the measurement was at 64% of the tensile strength of the control sample. From Table 6 it can be also seen that at values of stress 58 and 65% of the tensile strength the average number of cycles of the crosslinked, with a dose of100 kGy, sample 5 is more than 20% higher that the corresponding control (sample 4).

TABLE 5

| | | Control | PA66 + |
|---|---|---|---|
| | | non glass | 5% Taic |
| Description | Chemical Name | 4 | 5 |
| PA66 | Polyamide-6,6 (polymer) | 84.900% | 76.600% |
| Stabilizer | N,N′-hexane-1,6-diylbis(3- | 0.050% | 0.050% |
| | (3,5-di-tert-butyl-4- | | |
| | hydroxyphenylpropionamide | | |
| Stabilizer | (Tris(2,4-ditert- | 0.050% | 0.050% |
| | butylphenyl)phosphite) | | |
| Lubricant | Polytetrafluoroethylene | 15.000% | 15.000% |
| | powder | | |
| Crosslinker | 60 wt % triallyl isocyanurate | | 8.300% |
| masterbatch | in 40 wt % Polyamide-6 | | |

TABLE 6

| | | Sample 4 | | |
|---|---|---|---|---|
| | | (Control) | Sample 5 | |
| | | Dose | | |
| Test | | 0 kGy | 100 kGy | |
| Temperature | | Number of | Number of | Change vs. |
| 23° C. | Stress, | Cycles to | Cycles to | Control |
| Specimens | MPa | Failure | Failure | sample 4 |
| 1 | 0 | 1,000,000 | 1,000,000 | |
| 2 | 0 | 1,000,000 | 1,000,000 | |
| Average | | 1,000,000 | 1,000,000 | |
| 1 | 38 | 5,686 | 1,000,000 | |
| 2 | 38 | 5,572 | 1,000,000 | |
| Average | | 5,629 | 1,000,000 | 17,655% |
| 1 | 42 | 3,746 | 1,000,000 | |
| 2 | 42 | 3,291 | 1,000,000 | |
| Average | | 3,519 | 1,000,000 | 28,321% |
| 1 | 46 | 1,838 | 1,000,000 | |
| 2 | 46 | 1,034 | 1,000,000 | |
| 3 | 46 | 509 | | |
| Average | | 772 | 1,000,000 | 129,518% |

### Example 3

The compositions of table 1 we also made using a second supplier of polyamide-6,6. The corresponding samples, referred to as samples 7 and 8 (table 7), were used to test the effect on fatigue performance for different e-beam doses.

TABLE 7

| | | Sample 7 | |
|---|---|---|---|
| Component | Chemical Name (Description) | Control | Sample 8 |
| Polymer | Polyamide-6,6 (second supplier) | 54.90 | 49.40 |
| Stabilizer | N,N′-hexane-1,6-diylbis(3- | 0.05 | 0.05 |
| | (3,5-di-tert-butyl-4- | | |
| | hydroxyphenylpropionamide | | |
| Stabilizer | (Tris(2,4-ditert- | 0.05 | 0.05 |
| | butylphenyl)phosphite) | | |
| Lubricant | Polytetrafluoroethylene powder | 15.00 | 15.00 |
| Crosslinker | Masterbatch of 60 wt % triallyl | 0.00 | 5.50 |
| Masterbatch | isocyanurate in 40 wt % | | |
| | Polyamide-6 (Cross-linker) | | |
| Reinforcing | Chopped glass fiber | 30.00 | 30.00 |
| Fiber | | | |
| | Total (wt %) | 100 | 100 |

Tensile specimens corresponding to sample 8 were cross-linked by irradiating them with an e-beam source, using different doses of 25 kGy, 125 kGy and 400 kGy, in multiple passes each one of 25 kGy The tensile bars were contained in polyethylene plastic bags during exposure to the e-beam which was turned from one side to the other after each pass to allow a homogenous irradiation.

Sample 7 (not crosslinked) is the control sample corresponding to sample 8. The tensile strength of sample 7 (not crosslinked) is 150 MPa.

Table 8 shows the tensile fatigue results of the control, sample 7, compared to sample 8 crosslinked by using 3 different doses of 25, 125 and 400 kGy. The tensile fatigue was measured at a stress of 105 MPa that correspond to 70% of the tensile strength of the control (sample 7).

Results in table 8 show that the crosslinked sample 8, at all the 3 doses tested, has a higher average number of cycles to failure versus the corresponding control, sample 7. In particular the increase in average cycles to failure of sample 8, irradiated at 25, 125 and 400 kGy, is 42, 153 and 864% higher than the average number of cycles to failure measured for sample 7.

TABLE 8

| | | | | Change of | | Change of | | Change of |
|---|---|---|---|---|---|---|---|---|
| | | | | sample 8 at | | sample 8 at | | sample 8 at |
| | | | | 25 kGy vs. | | 125 kGy vs. | | 400 kGy vs. |
| | | Sample 7 | | control | | Control | | Control |
| | | (Control) | Sample 8 | sample 7 | Sample 8 | sample 7 | Sample 8 | sample 7 |
| | | Dose kGy | | | | | | |
| Test | | 0 | 25 | | 125 | | 400 | |
| Temperature | | Number of | Number of | | Number of | | Number of | |
| 23° C. | Stress, | Cycles to | Cycles to | | Cycles to | | Cycles to | |
| Specimens | MPa | Failure | Failure | | Failure | | Failure | |
| 1 | 105 | 1,108 | 1,587 | | 2,655 | | 9,155 | |
| 2 | 105 | 1,112 | 1,574 | | 2,655 | | 12,082 | |
| 3 | 105 | | | | 3,125 | | 10,857 | |
| Average | | 1,110 | 1,581 | 42% | 2,812 | 153% | 10,698 | 864% |

TABLE 9

| | | | | Change of | | Change of |
|---|---|---|---|---|---|---|
| | | | | sample 8 at | | sample 8 at |
| | | | | 125 kGy vs. | | 400 kGy vs. |
| | | Sample 7 | | Control | | Control |
| | | (Control) | Sample 8 | sample 7 | Sample 8 | sample 7 |
| | | Dose kGy | | | | |
| Test | | 0 | 125 | | 400 | |
| Temperature | | Number of | Number of | | Number of | |
| 150° C. | Stress, | Cycles to | Cycles to | | Cycles to | |
| Specimens | MPa | Failure | Failure | | Failure | |
| 1 | 105 | 53,135 | 141,203 | | 189,612 | |
| 2 | 105 | 90,200 | | | | |
| 3 | 105 | 71752 | | | | |
| Average | | 71,696 | 141,203 | 97% | 189,612 | 164% |

Table 9 shows tensile fatigue data measured at 150° C. It can be seen that crosslinked sample 8, irradiated at 125 and 400 kGy, has a higher average number of cycles to failure versus the corresponding control, sample 7. In particular the increase in average cycles to failure of sample 8, irradiated at 125 and 400 kGy, is 97 and 164% higher than the average number of cycles to failure measured for sample 7.

### Example 4

Two compositions using Molybdenum disulfide as lubricant, instead of polytetrafluoroethylene, were made, see Table 10. Fatigue tests were performed at 23 and 150° C. and corresponding results are reported in Table 11 and 12 respectively. Sample 9, which does not contain a cross-linker, is the corresponding control sample of sample 10 which contains a the cross-linker.

TABLE 10

| | | Sample 9 | |
|---|---|---|---|
| Component | Chemical Name (Description) | (control) | Sample 10 |
| Polymer | Polyamide-6,6 (second supplier) | 67.4 | 61.9 |
| Stabilizer | N,N′-hexane-1,6-diylbis(3-(3,5-di- | 0.05 | 0.05 |
| | tert-butyl-4- | | |
| | hydroxyphenylpropionamide | | |
| Stabilizer | (Tris(2,4-ditert- | 0.05 | 0.05 |
| | butylphenyl)phosphite) | | |
| Lubricant | Molybdenum disulfide | 2.5 | 2.5 |
| Crosslinker | Masterbatch of 60 wt % triallyl | 0 | 5.5 |
| Masterbatch | isocyanurate in 40 wt % | | |
| | Polyamide-6 (Cross-linker) | | |
| Reinforcing | Chopped glass fiber | 30 | 30 |
| Fiber | | | |
| | Total (wt %) | 100.00 | 100.00 |

Tensile specimens of Sample 10 were cross-linked by receiving a dose of 100 kGy using an e-beam source, in multiple passes (each one of 25 kGy). The tensile bars were contained in polyethylene plastic bags during exposure to the e-beam which was turned from one side to the other after each pass to allow a homogenous irradiation.

The tensile strength of the control, sample 9, at 23° C. was 170 MPa and 87 MPa 150° C. The tensile strength of sample 10, crosslinked by using 100 kGy dose, was 159 MPa and 23° C. and 63 MPa 150° C.

Tensile fatigue results reported tables 11 and 12 show that, at both at 23° C. and 150° C., the crosslinked sample 10 reaches a higher average number of cycles to failure versus the corresponding control, sample 9. In particular the increase in average cycles to failure of sample 10, irradiated 100 kGy, is more than 1000% higher than the average number of cycles to failure measured for sample 9, both at 23° C. and 150° C. In both cases the samples have been tested at a tensile strength that is 60% of the tensile strength of the control sample.

TABLE 11

| | | Sample 9 | | |
|---|---|---|---|---|
| | | (Control) | Sample 10 | |
| | | Dose kGy | | Change of |
| Test | | 0 | 100 | sample 10 |
| Temperature | | Number of | Number of | at 100 kGy |
| 23° C. | Stress, | Cycles to | Cycles to | vs. control |
| Specimens | MPa | Failure | Failure | sample 9 |
| 1 | 102 | 2,943 | 336,177 | |
| 2 | 102 | 2,521 | 580,449 | |
| 3 | 102 | 2614 | | |
| Average | | 2,693 | 458,313 | 16921% |

TABLE 12

| | | Sample 9 | | |
|---|---|---|---|---|
| | | (Control) | Sample 10 | |
| | | Dose kGy | | Change of |
| Test | | 0 | 25 | sample 10 |
| Temperature | | Number of | Number of | at 100 kGy |
| 150° C. | Stress, | Cycles to | Cycles to | vs. control |
| Specimens | MPa | Failure | Failure | sample 9 |
| 1 | 52.2 | 4,805 | 687,393 | |
| 2 | 52.2 | 7,504 | 391,471 | |
| 3 | | | | |
| Average | | 6,155 | 539,432 | 8665% |

The formulations 9 and 10 in table 10 contain 2.5% of wt. molybdenum disulfide, a different lubricant than polytetrafluoroethylene, and the corresponding fatigue data, in table 9 and 10, show that also in this case the crosslinked sample reaches a higher average number of fatigue cycles in comparison to the control sample.

### Example 5

Two compositions using chopped carbon fibers, instead of glass fibers, were made, see Table 13. Fatigue tests were performed at 23 and 150° C. and corresponding results are reported in Table 14 and 15 respectively. Sample 11, which does not contain a cross-linker, is the corresponding control sample of sample 12 which contains the cross-linker.

TABLE 13

| | | Sample 11 | |
|---|---|---|---|
| Component | Chemical Name (Description) | (control) | Sample 12 |
| Polymer | Polyamide-6,6 (second supplier) | 55 | 49.5 |
| Stabilizer | N,N′-hexane-1,6-diylbis(3-(3,5- | | |
| | di-tert-butyl-4- | | |
| | hydroxyphenylpropionamide | | |
| Stabilizer | (Tris(2,4-ditert- | | |
| | butylphenyl)phosphite) | | |
| Lubricant | Polytetrafluoroethylene powder | 15 | 15 |
| Crosslinker | Masterbatch of 60 wt % triallyl | 0 | 5.5 |
| Masterbatch | isocyanurate in 40 wt % | | |
| | Polyamide-6 (Cross-linker) | | |
| Reinforcing | Chopped Carbon Fiber | 30 | 30 |
| Fiber | | | |
| | Total (wt %) | 100.00 | 100.00 |

Tensile specimens of Sample 12 were cross-linked by receiving a dose of 100 kGy using an e-beam source, in multiple passes (each one of 25 kGy). The tensile bars were contained in polyethylene plastic bags during exposure to the e-beam which was turned from one side to the other after each pass to allow a homogenous irradiation.

The tensile strength of the control, sample 11, at 23° C. was 252 MPa and 109 MPa 150° C. The tensile strength of sample 12, crosslinked by using 100 kGy dose, was 236 MPa and 23° C. and 98 MPa 150° C.

TABLE 14

| | | Sample 11 | | |
|---|---|---|---|---|
| | | (Control) | Sample 12 | |
| | | Dose kGy | | Change of |
| Test | | 0 | 100 | sample 12 |
| Temperature | | Number of | Number of | at 100 kGy |
| 23° C. | Stress, | Cycles to | Cycles to | vs. control |
| Specimens | MPa | Failure | Failure | sample 11 |
| 1 | 151.2 | 5,125 | 274,164 | |
| 2 | 151.2 | 5,228 | 233,751 | |
| 3 | 151.2 | 4868 | 304987 | |
| Average | | 5,074 | 270,967 | 5241% |

TABLE 15

| | | Sample 11 | | |
|---|---|---|---|---|
| | | (Control) | Sample 12 | |
| | | Dose kGy | | Change of |
| Test | | 0 | 100 | sample 12 |
| Temperature | | Number of | Number of | at 100 kGy |
| 150° C. | Stress, | Cycles to | Cycles to | vs. control |
| Specimens | MPa | Failure | Failure | sample 11 |
| 1 | 65.4 | 142,776 | 381,504 | |
| 2 | 65.4 | 143,948 | 340,299 | |
| 3 | | | | |
| Average | | 143,362 | 360,902 | 152% |

Tensile fatigue results reported tables 14 and 15 show that, at both at 23° C. and 150° C., the crosslinked sample 12 reaches a higher average number of cycles to failure versus the corresponding control, sample 11. In particular the increase in average cycles to failure of sample 12, irradiated 100 kGy, is more than 100% higher than the average number of cycles to failure measured for the corresponding control sample 11, both at 23° C. and 150° C. In both cases the samples have been tested at 60% of the tensile strength of the control sample.

The results in tables 13, 14, 15 demonstrate that the crosslinked sample reaches a higher average number of fatigue cycles in comparison to the control sample, not only in compositions containing glass fibers, but also in compositions where other fibers are present, like for example carbon fibers.

### Example 6

Two compositions containing 55% by wt. of chopped glass fibers were made, see Table 16. Fatigue tests were performed at 23 and 150° C. and the corresponding results are reported in Table 17 and 18 respectively. Note that sample 13, which does not contain cross-linker, is the corresponding control sample of sample 14, which does contain the cross-linker.

TABLE 16

| | | Sample 13 | |
|---|---|---|---|
| Component | Chemical Name (Description) | (control) | Sample 14 |
| Polymer | Polyamide-6,6 (second | 29.9 | 26.9 |
| | supplier) | | |
| Stabilizer | N,N′-hexane-1,6-diylbis(3- | 0.05 | 0.05 |
| | (3,5-di-tert-butyl-4- | | |
| | hydroxyphenylpropionamide | | |
| Stabilizer | (Tris(2,4-ditert- | 0.05 | 0.05 |
| | butylphenyl)phosphite) | | |
| Lubricant | Polytetrafluoroethylene | 15 | 15 |
| | powder | | |
| Crosslinker | Masterbatch of 60 wt % triallyl | 0 | 3 |
| Masterbatch | isocyanurate in 40 wt % | | |
| | Polyamide-6 | | |
| Reinforcing | Chopped Glass Fiber | 55 | 55 |
| Fiber | | | |
| | Total (wt %) | 100.00 | 100.00 |

Tensile specimens of Sample 14 were cross-linked by receiving a dose of 100 kGy using an e-beam source, in multiple passes (each one of 25 kGy). The tensile bars were contained in polyethylene plastic bags during exposure to the e-beam which was turned from one side to the other after each pass to allow a homogenous irradiation.

The tensile strength of the control, sample 13, at 23° C. was 220 MPa and 96 MPa 150° C. The tensile strength of sample 14, crosslinked by using 100 kGy dose, was 196 MPa and 23° C. and 73 MPa 150° C.

TABLE 17

| | | Sample 13 | | |
|---|---|---|---|---|
| | | (Control) | Sample 14 | |
| | | Dose kGy | | Change of |
| Test | | 0 | 100 | sample 14 at |
| Temperature | | Number of | Number of | 100 kGy vs. |
| 23° C. | Stress, | Cycles to | Cycles to | control |
| Specimens | MPa | Failure | Failure | sample 13 |
| 1 | 132 | 3,274 | 3,725 | |
| 2 | 132 | 3,395 | 4,007 | |
| 3 | 132 | 2818 | 4200 | |
| Average | | 3,162 | 3,977 | 26% |

TABLE 18

| | | Sample 13 | | |
|---|---|---|---|---|
| | | (Control) | Sample 14 | |
| | | Dose kGy | | Change of |
| Test | | 0 | 100 | sample 14 at |
| Temperature | | Number of | Number of | 100 kGy vs. |
| 150° C. | Stress, | Cycles to | Cycles to | control |
| Specimens | MPa | Failure | Failure | sample 13 |
| 1 | 57.6 | 102,287 | 199,366 | |
| 2 | 57.6 | | 198,165 | |
| 3 | | | | |
| Average | | 102,287 | 198,766 | 94% |

Tensile fatigue results reported tables 17 and 18 show that, at both at 23° C. and 150° C., the crosslinked sample 14 reaches a higher average number of cycles to failure versus the corresponding control, sample 13. In particular the increase in average cycles to failure of sample 14, irradiated 100 kGy, is 26% (TABLE 17) and 94% (TABLE 18) higher than the average number of cycles to failure measured for the corresponding control sample 13, at 23° C., and 150° C. respectively. In both cases the samples have been tested at 60% of the tensile strength of the control sample.

The results in tables 16, 17, 18 demonstrate that the crosslinked sample reaches a higher average number of fatigue cycles in comparison to the control sample in compositions where high amount of fibers and low amount of cross-linker are present.

### Example 7

A composition containing a different cross linker, namely trimethallyl isocyanurate, than the one used in the other examples has been made, see sample 15, in table 19 the composition of sample 7 has been reported again since sample 7 is the control sample corresponding to sample 15.

Fatigue tests were performed at 23° C. and the corresponding results are reported in Table 20. Note that table 20 shows a comparison of the fatigue performance of sample 7 with sample 15, the latter being crosslinked by using a dose of 100 kGy and not being crosslinked (0 kGy). The samples in table 20 were tested at 105 MPa, which corresponds to 60% of the tensile strength of the control sample 7. Fatigue data of sample 7 were reported again to make the comparison easier to the reader. The crosslinked sample 15, dose100 kGy, shows a higher average fatigue cycles before breakage (plus 73%) in comparison to the control sample 7. It is mention that the same sample 15 before being crosslinked, i.e. 0 kGy, does not show any improvement of number of fatigue cycles, but instead a slight decrease when compared to sample 7.

TABLE 19

| | Chemical Name | Sample 7 | |
|---|---|---|---|
| Component | (Description) | Control | Sample 15 |
| Polymer | Polyamide-6,6 (second | 54.9 | 51.3 |
| | supplier) | | |
| Stabilizer | N,N′-hexane-1,6-diylbis(3- | 0.05 | 0.05 |
| | (3,5-di-tert-butyl-4- | | |
| | hydroxyphenylpropionamide | | |
| Stabilizer | (Tris(2,4-ditert- | 0.05 | 0.05 |
| | butylphenyl)phosphite) | | |
| Lubricant | Polytetrafluoroethylene | 15 | 15 |
| | powder | | |
| Crosslinker | Masterbatch of 60 wt % | 0 | 0 |
| Masterbatch | triallyl isocyanurate in 40 wt | | |
| | % Polyamide-6 | | |
| | (Cross-linker) | | |
| Crosslinker | Trimethallyl isocyanurate | | 3.6 |
| Reinforcing | Chopped glass fiber | 30 | 30 |
| Fiber | | | |
| | Total (wt %) | 100 | 100 |

TABLE 20

| | | | | Change of | | Change of |
|---|---|---|---|---|---|---|
| | | | | sample 15 at | | sample 15 at |
| | | | | 0 kGy vs. | | 100 kGy vs. |
| | | Sample 7 | | control | | control |
| | | (Control) | Sample 15 | sample 7 | Sample 15 | sample 7 |
| | | Dose kGy | | | | |
| Test | | 0 | 0 | | 100 | |
| Temperature | | Number of | Number of | | Number of | |
| 23° C. | Stress, | Cycles to | Cycles to | | Cycles to | |
| Specimens | MPa | Failure | Failure | | Failure | |
| 1 | 105 | 1,108 | 939 | | 1,582 | |
| 2 | 105 | 1,112 | 788 | | 1,910 | |
| 3 | 105 | | 883 | | 2253 | |
| Average | | 1,110 | 870 | −22% | 1,915 | 73% |

### Example 8

Two compositions containing low (1.02% wt.) and high (9.0% wt.) amount of cross-linker of were made, see Table 21 sample 16 and 17. The corresponding control, sample 7, is also reported to make the comparison easier to the reader.

Fatigue tests were performed at 23 and 150° C. and the corresponding results are reported in Table 22 and 23 respectively. The fatigues test were performed at stress values equal to 60% of the tensile strength, measured respectively at 23 and 150° C., of the control sample. It is apparent in tables 22 and 23 that the crosslinked samples 16 and 17, irradiated with dose of 100 kGy, reach a larger average number of fatigue cycles than the corresponding control sample 7. These results prove that changing the amount (percentage) of crosslinker has a positive effect on the fatigue resistance of the polymer.

TABLE 21

| | | Sample | | |
|---|---|---|---|---|
| | Chemical Name | 7 | Sample | Sample |
| Component | (Description) | Control | 16 | 17 |
| Polymer | Polyamide-6,6 (second | 54.9 | 53.2 | 39.9 |
| | supplier) | | | |
| Stabilizer | N,N′-hexane-1,6-diylbis(3- | 0.05 | 0.05 | 0.05 |
| | (3,5-di-tert-butyl-4- | | | |
| | hydroxyphenylpropionamide | | | |
| Stabilizer | (Tris(2,4-ditert- | 0.05 | 0.05 | 0.05 |
| | butylphenyl)phosphite) | | | |
| Lubricant | Polytetrafluoroethylene | 15 | 15 | 15 |
| | powder | | | |
| Crosslinker | Masterbatch of 60 wt % | 0 | 1.7 | 15 |
| Masterbatch | triallyl isocyanurate in 40 wt | | | |
| | % Polyamide-6 | | | |
| | (Cross-linker) | | | |
| Reinforcing | Chopped glass fiber | 30 | 30 | 30 |
| Fiber | | | | |
| | Total (wt %) | 100 | 100 | 100 |

TABLE 22

| | | | | Change of | | Change of |
|---|---|---|---|---|---|---|
| | | | | sample 16 at | | sample 17 at |
| | | | | 0 kGy vs. | | 100 kGy vs. |
| | | Sample 7 | | control | | control |
| | | (Control) | Sample 16 | sample 7 | Sample 17 | sample 7 |
| | | Dose kGy | | | | |
| Test | | 0 | 100 | | 100 | |
| Temperature | | Number of | Number of | | Number of | |
| 23° C. | Stress, | Cycles to | Cycles to | | Cycles to | |
| Specimens | MPa | Failure | Failure | | Failure | |
| 1 | 105 | 1,108 | 1,340 | | 74,175 | |
| 2 | 105 | 1,112 | 1,269 | | 38,445 | |
| 3 | 105 | | 1426 | | 99477 | |
| Average | | 1,110 | 1,345 | 21% | 70,699 | 6269% |

TABLE 23

| | | | | Change of | | Change of |
|---|---|---|---|---|---|---|
| | | | | sample 16 at | | sample 17 at |
| | | | | 0 kGy vs. | | 100 kGy vs. |
| | | Sample 7 | | control | | control |
| | | (Control) | Sample 16 | sample 7 | Sample 17 | sample 7 |
| | | Dose, kGy | | | | |
| Test | | 0 | 100 | | 100 | |
| Temperature | | Number of | Number of | | Number of | |
| 150° C. | Stress, | Cycles to | Cycles to | | Cycles to | |
| Specimens | MPa | Failure | Failure | | Failure | |
| 1 | 48.6 | 53,135 | | | 1,000,000 | |
| 2 | 48.6 | 90,200 | | | 1,000,000 | |
| 3 | 48.6 | 71752 | | | | |
| Average | | 71,696 | | # | 1,000,000 | 1295% |

### Example 9

Additional compositions were made with a different polymer than PA66. Table 24 shows 3 samples where the polymer is a polyester, namely polybutylene terephthalate. The sample 18 (table 22) is the control sample corresponding to the samples 19 and 20, both containing the cross-linker. The tensile bars of samples 19 and 20 have been crosslinked by irradiating them with different doses of 100, 250 and 400 kGy.

TABLE 24

| | Chemical Name | Sample 18 | Sample | Sample |
|---|---|---|---|---|
| Component | (Description) | (control) | 19 | 20 |
| Polymer | Polybutylene | 55 | 51.5 | 48 |
| | terephthalate | | | |
| Lubricant | Polytetrafluoroethylene | 15 | 15 | 15 |
| | powder | | | |
| Crosslinker | Triallyl isocyanurate | 0 | 3.5 | 7 |
| Reinforcing | Chopped glass fiber | 30 | 30 | 30 |
| Fiber | | | | |
| | Total (wt %) | 100 | 100 | 100 |

Fatigue tests were performed at 23 and 150° C. and the corresponding results are reported in Table 25a, 25b, 26a and 26b respectively. The fatigues test were performed at stress values equal to 60% of the tensile strength, measured respectively at 23 and 150° C., of the control sample. The control sample 18 has a tensile strength of 125 MPa and 51 MPa, at 23 and 150° C. respectively.

TABLE 25a

| | | | | Change of | | Change of |
|---|---|---|---|---|---|---|
| | | | | sample 19 at | | sample 20 at |
| | | | | 250 kGy vs. | | 250 kGy vs. |
| | | Sample 18 | | control | | control |
| | | (Control) | Sample 19 | sample 18 | Sample 20 | sample 18 |
| | | Dose kGy | | | | |
| Test | | 0 | 250 | | 250 | |
| Temperature | | Number of | Number of | | Number of | |
| 23° C. | Stress, | Cycles to | Cycles to | | Cycles to | |
| Specimens | MPa | Failure | Failure | | Failure | |
| 1 | 75 | 5,233 | 118,955 | | 21,880 | |
| 2 | 75 | 5,617 | 60,064 | | 39,976 | |
| 3 | 75 | 6086 | 253989 | | 14378 | |
| Average | | 5,645 | 144,336 | 2457% | 25,411 | 350% |

TABLE 25b

| | | Sample | | Sample | |
|---|---|---|---|---|---|
| | | 19 | | 19 | |
| | | Dose kGy | | | |
| | | 100 | | 400 | |
| | | | Change of | Number | Change of |
| Test | | | sample 20 at | of | sample 19 at |
| Temperature | | Number | 100 kGy vs. | Cycles | 400 kGy vs. |
| 23° C. | Stress, | of Cycles | control | to | control |
| Specimens | MPa | to Failure | sample 18 | Failure | sample 18 |
| 1 | 75 | 42,350 | | 126,672 | |
| 2 | 75 | 41,288 | | 84,698 | |
| 3 | 75 | | | 128105 | |
| Average | | 41,819 | 641% | 113,158 | 1904% |

TABLE 26a

| | | | | Change of | | Change of |
|---|---|---|---|---|---|---|
| | | | | sample 19 at | | sample 20 at |
| | | | | 250 kGy vs. | | 250 kGy vs. |
| | | Sample 18 | | control | | control |
| | | (Control) | Sample 19 | sample 18 | Sample 20 | sample 18 |
| | | Dose kGy | | | | |
| Test | | 0 | 250 | | 250 | |
| Temperature | | Number | Number | | Number | |
| 150° C. | Stress, | of Cycles | of Cycles | | of Cycles | |
| Specimens | MPa | to Failure | to Failure | | to Failure | |
| 1 | 30.6 | 22,635 | 1,000,000 | | 1,000,000 | |
| 2 | 30.6 | 25,125 | 1,000,000 | | 1,000,000 | |
| 3 | 30.6 | | | | | |
| Average | | 23,880 | 1,000,000 | 4088% | 1,000,000 | 4088% |

TABLE 26b

| | | Sample 19 | |
|---|---|---|---|
| | | Dose kGy | Change of |
| Test | | 100 | sample 20 at |
| Temperature | | Number of | 100 kGy vs. |
| 150° C. | Stress, | Cycles to | control |
| Specimens | MPa | Failure | sample 18 |
| 1 | 30.6 | 765,945 | |
| 2 | 30.6 | 793,261 | |
| 3 | 30.6 | | |
| Average | | 779,603 | 3165% |

It is apparent from the results in tables 25 and 26 that the crosslinked samples 19 and 20, irradiated with different doses of 100, 250 and 400 kGy, reach a larger average number of fatigue cycles than the corresponding control sample 18. These results prove that our findings go beyond polyamides and are also applicable to other polymer families

### Example 10

Additional compositions were made were made for which the cross-lining was not induced by using an e-beam source, but by applying heat to the sample at a certain temperature for a certain time. In some cases, in the following examples, the fatigue performance comparison will be done with the control samples (i.e. not containing the crosslinker) being annealed at the same temperature and time conditions used to crosslink the corresponding crosslinked sample. This is done to take into account eventual increase of crystallinity and release of internal stresses due to the annealing of the samples above the glass transition, which could in turn influence fatigue performance.

TABLE 27

| | | Sample 21 | Sample |
|---|---|---|---|
| Component | Chemical Name (Description) | Control | 22 |
| Polymer | Polyamide-6 | 85 | 81 |
| Cross-linker | 4-(methylethynyl phthalic anhydride | 0 | 2 |
| Booster | Hexamethylene-1,6-di(4- | 0 | 2 |
| | methylethynyl)phthalimide | | |
| Lubricant | Polytetrafluoroethylene powder | 15.00 | 15.00 |
| | Total (wt %) | 100 | 100 |

The compositions made in Table 27 was tested as shown in Table 28 with and without heating the molded parts of Sample 21 and with heating (crosslinking) the molded parts of Sample 22. In particular Sample 22 was cross-linked by heating the molded part (tensile bars) in an oven for 24 hrs at 200° C.

An indirect verification of the occurrence of the crosslinking was seen by dynamic mechanical analyzer (DMA) by measuring the storage modulus above 225° C. (melting temperature of polyamide-6) of a tensile bar of the formulation of Sample 22 after heating the tensile bar in an oven for 24 hrs at 200° C. and comparing it with the storage modulus of the control sample (Sample 21), either heated in an oven for 24 hrs at 200° C. or not heated in an oven for 24 hrs at 200° C. The storage modulus of bars of Sample 22, heated in an oven for 24 hrs at 200° C., is 2 MPa or higher, at temperature between 225-250° C., while the DMA of the control sample (Sample 21), either heated in an oven for 24 hrs at 200° C. or not heated in an oven for 24 hrs at 200° C. , showed no storage modulus at temperatures between 225-250° C., in line with the fact that polyamide-6 is above is melting temperature (Tₘ).

Tensile fatigue life has been measured using (ISO) tensile bars. Results are given in the Table 28. In Table 28, the number of cycles to failure observed using tensile fatigue on ISO tensile bars at 23° C. is shown. Stress ration of 0.1 and a frequency of 5 Hz was used. All specimens were conditioned for 48 hrs, at 23° C. and 50% relative humidity before testing. The specimens that reached 1 million cycles did not show any failure and the test was stopped.

The control sample had a tensile strength of 53.0 MPa and Sample 22 had a tensile strength of 53 MPa as measured by ISO 527-1. At a stress of 37 MPa, the measurement was at 70% of the tensile strength of the control sample.

TABLE 28

| | | | Sample 21, | | | |
|---|---|---|---|---|---|---|
| | | Sample 21 | control, | | | |
| | | control | heated | Sample 22 | | |
| | | Time (h) of exposure at 200° C. | | | | Change of |
| Test | | 0 | 24 | 24 | Change of | sample 22 |
| Temperature | | Number of | Number | Number of | sample 22 | vs. control |
| 23° C. | Stress, | Cycles to | of Cycles | Cycles to | vs. control | sample 21, |
| Specimens | MPa | Failure | to Failure | Failure | sample 21 | heated |
| 1 | 37 | 1978 | 249853 | 1,000,000 | | |
| 2 | 37 | 2304 | 135660 | 1,000,000 | | |
| 3 | 37 | — | 113877 | | | |
| Average | | 2141 | 166463 | 1,000,000 | 46,607% | 500% |

From Table 26 it can be seen that, at values of stress 70% of the tensile strength, the average number of cycles to failure of sample 22 is more than 500% higher compared to the control (sample 21) that was heated in an oven for 24 hrs at 200° C. and more than 46,607% higher to a control sample which was not heated in oven.

The results prove the positive effect on the fatigue resistance obtainable by cross-linking the samples.

### Example 11

Sample 22 was also cross-linked by heating the molded part (tensile bars) in an oven for 6 hrs and 48 hrs at 200° C. Fatigue tests were performed and results reported in Table 29.

TABLE 29

| | | Sample 21 | | | | |
|---|---|---|---|---|---|---|
| | | control | Sample 22 | Sample 22 | | |
| | | Time of exposure at 200° C. | | | Change of | Change of |
| Test | | 0 | 6 | 48 | sample | sample |
| Temperature | | Number of | Number of | Number of | 22, 6 hrs | 22, 48 hrs |
| 23° C. | Stress, | Cycles to | Cycles to | Cycles to | vs. control | vs. control |
| Specimens | MPa | Failure | Failure | Failure | sample 21 | sample 21 |
| 1 | 37 | 1978 | 155195 | 112393 | | |
| 2 | 37 | 2304 | 174725 | 77000 | | |
| 3 | 37 | — | 374517 | 150367 | | |
| Average | | 2141 | 234812 | 94697 | 10,867% | 4,323% |

### Examples 12 and 13

Additional compositions were prepared and summarized in Table 30 and Table 31. In Table 30 a composition without booster (Example 12) is depicted. In Table 31 a composition with reinforced fiber is depicted (Example 13)

TABLE 30

| | | Sample 21, | |
|---|---|---|---|
| Component | Chemical Name (Description) | control | Sample 23 |
| Polymer | Polyamide-6 | 85 | 83.75 |
| Cross-linker | 4-(methylethynyl phthalic | 0 | 1.25 |
| | anhydride | | |
| Booster | Hexamethylene-1,6-di(4- | 0 | 0 |
| | methylethynyl)phthalimide | | |
| Lubricant | Polytetrafluoroethylene powder | 15 | 15 |
| | Total (wt %) | 100 | 100 |

TABLE 31

| | | Sample 24 | |
|---|---|---|---|
| Component | Chemical Name (Description) | control | Sample 25 |
| Polymer | Polyamide-6 | 55 | 52.48 |
| Cross-linker | 4-(methylethynyl phthalic | 0 | 1.26 |
| | anhydride | | |
| Booster | Hexamethylene-1,6-di(4- | 0 | 1.26 |
| | methylethynyl)phthalimide | | |
| Lubricant | Polytetrafluoroethylene powder | 15 | 15 |
| Reinforcing | Chopped glass fiber | 30 | 30 |
| Fiber | | | |
| | Total (wt %) | 100 | 100 |

Fatigue tests were performed and results reported in Table 32 and Table 33. The control sample 21 had a tensile strength of 53.0 MPa. At a stress of 37 MPa, the measurement was at 70% of the tensile strength of the control sample. The control sample 24 had a tensile strength of 151.0 MPa. At a stress of 106 MPa, the measurement was at 70% of the tensile strength of the control sample.

TABLE 32

| | | Sample 21, | | |
|---|---|---|---|---|
| | | control | Sample 23 | |
| | | Time of | | |
| | | exposure | | |
| | | at 200° C. | | |
| Test | | 0 | 24 | Change of |
| Temperature | | Number of | Number of | sample 23 vs. |
| 23° C. | Stress, | Cycles to | Cycles to | sample 21, |
| Specimens | MPa | Failure | Failure | control |
| 1 | 37 | 1978 | 440481 | |
| 2 | 37 | 2304 | | |
| 3 | 37 | — | | |
| Average | | 2141 | 440481 | 20474% |

TABLE 33

| | | | Sample 24, | | | |
|---|---|---|---|---|---|---|
| | | Sample 24, | control, | | | |
| | | control | heated | Sample 25 | | |
| | | Time of exposure at 200° C. | | | | Change of |
| Test | | 0 | 24 | 24 | Change of | sample 25 |
| Temperature | | Number | Number | Number of | 25 vs. | vs. control |
| 23° C. | Stress, | of Cycles | of Cycles | Cycles to | control | sample 24, |
| Specimens | MPa | to Failure | to Failure | Failure | sample 24 | heated |
| 1 | 106 | 456 | 1268 | 4461 | | |
| 2 | 106 | 462 | 1495 | 4706 | | |
| 3 | 106 | | | | | |
| Average | | 459 | 1382 | 4584 | 899% | 231% |

### Example 14

In Table 34, the number of cycles to failure observed during tensile fatigue on ISO tensile-bars at a temperature of 150° C. The control sample 26 had a tensile strength of 54.0 MPa at 150° C. At a stress of 38 MPa, the measurement was at 70% of the tensile strength of the control sample.

TABLE 34

| | | | Sample 24, | | | |
|---|---|---|---|---|---|---|
| | | Sample 24, | control, | | | |
| | | control | heated | Sample 25 | | |
| | | Time of exposure at 200° C. | | | | Change of |
| Test | | 0 | 24 | 24 | Change of | sample 25 |
| Temperature | | Number of | Number of | Number of | 25 vs. | vs. control |
| 150° C. | Stress, | Cycles to | Cycles to | Cycles to | control | sample 24, |
| Specimens | MPa | Failure | Failure | Failure | sample 24 | heated |
| 1 | 38 | 3883 | 104159 | 244134 | | |
| 2 | 38 | | 83811 | 154204 | | |
| 3 | 38 | | | 380532 | | |
| Average | | 3883 | 93985 | 244134 | 6,187% | 160% |

From Tables 28 and 29 and from 33 and 34 it can be seen that samples 22, 23 and 25 show a number of cycles to failure that is at least one order of magnitude higher than the corresponding control. Remarkably, an improvement in fatigue life is shown over a wide range of temperature, i.e. at both 23 and 150° C.

From Table 29 it can be also seen that an increased fatigue can be obtained by heating the molded part for different hours.

From Table 32 it can be seen that an increased fatigue can be obtained, by heating the molded part for 24 hrs at 200° C., from formulations that contain, besides a cross-linking agent, a boosters and from formulations in which no booster is present.

From Tables 33 and table 34 it can be seen that an increased fatigue can be obtained, by heating the molded part for 24 hrs at 200° C., from formulations that contain, besides a cross-linking agent, a reinforced fiber.

Beside composition based on polyamide 6, additional compositions based on polyamide 6,6 were prepared which are summarized in Tables 35a and 36b.

TABLE 35a

| | Chemical Name | Sample | Sample 26, | Sample 28, | Sample |
|---|---|---|---|---|---|
| Component | (Description) | control | 27 | control | 29 |
| Polymer | Polyamide-6,6 | 100 | 96 | 85 | 81.6 |
| Cross- | 4-(methylethynyl | 0 | 2 | | 1.7 |
| linker | phthalic anhydride | | | | |
| Booster | Hexamethylene-1,6- | 0 | 2 | | 1.7 |
| | di(4-methylethynyl)phthalimide | | | | |
| Lubricant | Polytetrafluoroethylene | 0 | | 15 | 15 |
| | powder | | | | |
| Reinforcing | Chopped glass fiber | | | | |
| Fiber | | | | | |
| | Total (wt %) | 100 | 100 | 100 | 100 |

TABLE 35b

| | Chemical Name | Sample 30, | Sample | Sample 32, | Sample |
|---|---|---|---|---|---|
| Component | (Description) | control | 31 | control | 33 |
| Polymer | Polyamide-6,6 | 70 | 67.2 | 55 | 51.6 |
| Cross- | 4-(methylethynyl | | 1.4 | | 1.7 |
| linker | phthalic anhydride | | | | |
| Booster | Hexamethylene-1,6- | | 1.4 | | 1.7 |
| | di(4-methylethynyl)phthalimide | | | | |
| Lubricant | Polytetrafluoroethylene | | | 15 | 15 |
| | powder | | | | |
| Reinforcing | Chopped glass fiber | 30 | 30 | 30 | 30 |
| Fiber | | | | | |
| | Total (wt %) | 100 | 100 | | |

The composition made in table 35 were tested as shown in Tables from 36 to 39 with and without heating the molded part and the compositions made in sample 27, 29, 31 and 33 were tested with heating the molded part. Samples 27, 29, 31 and 33 were cross-linked by heating the molded part (tensile bars) in an oven for 8 hrs at 230° C.

Similar to polyamide 6 dynamic mechanical analyzer (DMA) was used to confirm cross-lining by the presence of a modulus above Tₘ

### Examples 15-18

Fatigue test were performed at 23° C. and the results are reported in Tables 36-39. The control samples 26, 28, 30 and 32 had a tensile strength of 71.0, 65, 186, and 162 MPa, respectively as measured by ISO 527-1. At a stress of 49.7, 45.5, 130.2, and 186 and 162 MPa, the measurements were at 70% of the tensile strength of the control samples 26, 28, 30 and 32, respectively.

TABLE 36

| | | | Sample 26 | | | |
|---|---|---|---|---|---|---|
| | | Sample 26 | control, | | | |
| | | control | heated | Sample 27 | | Change of |
| | | Time of exposure at 230° C. | | | Change of | sample |
| Test | | 0 | 8 | 8 | sample | 27 vs. |
| Temperature | | Number of | Number of | Number of | 27vs. | Control |
| 23° C. | Stress, | Cycles to | Cycles to | Cycles to | Control | sample 26 |
| Specimens | MPa | Failure | Failure | Failure | sample 26 | heated |
| 1 | 49.7 | 1786 | 1 | 13791 | | |
| 2 | 49.7 | 3655 | 1 | 10291 | | |
| 3 | 49.7 | 4210 | | | | |
| Average | | 3217 | 1 | 12041 | 274% | 1,204,000% |

TABLE 37

| | | | Sample | | |
|---|---|---|---|---|---|
| | | | 28, | | |
| | | Sample 28 | control, | | Change |
| | | control | heated | Sample 29 | of |
| | | Time of exposure | | | sample |
| | | at 230° C. | | | 29 vs. |
| Test | | 0 | 8 | 8 | Control |
| Temperature | | Number of | Number | Number of | sample |
| 23° C. | Stress, | Cycles to | of Cycles | Cycles to | 28 |
| Specimens | MPa | Failure | to Failure | Failure | heated |
| 1 | 45.5 | 1695 | 1 | 354 | |
| 2 | 45.5 | 1879 | 1 | | |
| 3 | 45.5 | | | | |
| Average | | 1787 | 1 | 354% | 35,300% |

TABLE 38

| | | | Sample 30, | | | |
|---|---|---|---|---|---|---|
| | | Sample 30, | control, | | | |
| | | control | heated | Sample 31 | | Change of |
| | | Time of exposure at 230° C. | | | Change of | sample |
| Test | | 0 | 8 | 8 | sample | 31vs. |
| Temperature | | Number of | Number of | Number of | 31vs. | Control |
| at 23° C. | Stress, | Cycles to | Cycles to | Cycles to | Control | sample 30 |
| Specimens | MPa | Failure | Failure | Failure | sample 30 | heated |
| 1 | 130.2 | 563 | 1343 | 2174 | | |
| 2 | 130.2 | 615 | 1296 | 2443 | | |
| 3 | 130.2 | | | | | |
| Average | | 589 | 1320 | 2309 | 292% | 75% |

TABLE 39

| | | | Sample 32, | | | |
|---|---|---|---|---|---|---|
| | | Sample 32, | control, | | | |
| | | control | heated | Sample 33 | | |
| | | Time of exposure at 230° C. | | | | Change of |
| Test | | 0 | 8 | 8 | Change of | sample 33 |
| Temperature | | Number of | Number of | Number of | sample 33 | vs. Control |
| 23° C. | Stress, | Cycles to | Cycles to | Cycles to | vs. Control | sample 32, |
| Specimens | MPa | Failure | Failure | Failure | sample 32 | heated |
| 1 | 162 | 782 | 1086 | 4114 | | |
| 2 | 162 | 739 | 1753 | 3974 | | |
| 3 | 162 | | | | | |
| Average | | 761 | 1421 | 4044 | 432% | 185% |

### Example 19

In Table 40, the number of cycles to failure observed during tensile fatigue on ISO tensile-bars at a temperature of 150° C. The tests use a stress ratio 0.1 and frequency 5 Hz. All specimens were conditioned for 48 hrs, at 23° C. and 50% relative humidity before testing. The control sample 32 had a tensile strength of 59.0 MPa at 150° C. At a stress of 41.3 MPa, the measurement was at 70% of the tensile strength of the control sample.

TABLE 40

| | | Sample 32 | | |
|---|---|---|---|---|
| | | control | Sample 33 | |
| | | Time | | |
| | | exposed at | | |
| | | 230° C. | | Change of |
| Test | | 0 | 8 | sample 33 |
| Temperature | | Number of | Number of | vs. |
| 150° C. | Stress, | Cycles to | Cycles to | Control |
| Specimens | MPa | Failure | Failure | sample 32 |
| 1 | 41.3 | 35221 | 436170 | |
| 2 | 41.3 | 37087 | 231399 | |
| 3 | 41.3 | | | |
| Average | | 36154 | 333785 | 823% |

From Tables 36-40, it can be seen that samples 27, 29, 31 and 33 show a number of cycles that is at least one order of magnitude higher than the control sample. Remarkably, an improvement in fatigue life is shown over a wide range of temperature, i.e. at both 23 and 150° C.

### Definitions

It is to be understood that the terminology used herein is for the purpose of describing particular aspects only and is not intended to be limiting. As used in the specification and in the claims, the term “comprising” can include the embodiments “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural equivalents unless the context clearly dictates otherwise. Thus, for example, reference to “a polycarbonate polymer” includes mixtures of two or more polycarbonate polymers.

The term “acetylenic compound” denotes a compound having at least one carbon-carbon triple bond.

As used herein, the term “combination” is inclusive of blends, mixtures, alloys, reaction products, and the like.

Ranges can be expressed herein as from one particular value to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±5% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Disclosed are the components to be used to prepare the compositions of the disclosure as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

As used herein the terms “weight percent,” “wt. %,” and “wt. %” of a component, which can be used interchangeably, unless specifically stated to the contrary, are based on the total weight of the formulation or composition in which the component is included. For example if a particular element or component in a composition or article is said to have 8% by weight, it is understood that this percentage is relative to a total compositional percentage of 100% by weight.

Unless specified to the contrary herein, all test standards are the most recent standard in effect at the time of filing this application

“Min” is the abbreviation for minutes. “Hrs” refers to hours. “° C.” is degrees Celsius. kGy refers to the radiation unit kilogray. “MPa” represents megapascal. “GPa” refers to gigapascal. “kJ” refers to kilojoules. “m” is the abbreviation for meter.

1. A composition comprising:
from about 40 wt. % to about 99.95 wt. % of a polymer base resin;
from 0 wt. % to about 60 wt. % of a reinforcing filler;
from 0 wt. % to about 25 wt. % of a lubricant; and
from about 0.05 wt. % to about 10 wt. % of a cross-linking agent;
wherein the composition is treated to induce cross-linking;
wherein the composition exhibits a number of tensile fatigue cycles to failure, measured at: at least one of 23° C. and 150° C., a frequency of 5 Hz, and a stress ratio of 0.1, that is at least 20% higher than the number of tensile fatigue cycles to failure exhibited by a control composition corresponding to the untreated composition without the cross-linking agent, when measured under a stress that is at least one of 10% or 20% or 30% or 40% or 50% or 60% or 70% or 80% or 90% of the tensile strength of the control composition, the tensile strength measured according to ISO 527-1; and
wherein the combined weight percent value of all components does not exceed 100 wt %, and wherein all weight percent values are based on the total weight of the composition.

2. The composition of claim 1 comprising:
from about 45 wt. % to about 79 wt. % of a polymer base resin;
from about 10 wt. % to about 50 wt. % of a reinforcing filler;
from about 10 wt. % to about 20 wt. % of a lubricant; and
from about 1 wt. % to about 5 wt. % of a cross-linking agent.

3. The composition of claim 1, wherein the composition exhibits a number of tensile fatigue cycles to failure measured at 23° C., a frequency of 5 Hz and a stress ratio of 0.1 that is at least 40% higher than the number of tensile fatigue cycles to failure exhibited by a control composition, corresponding to an untreated composition without the cross-linking agent, when measured under a stress that is 60% of the tensile strength of the control composition, the tensile strength measured according to ISO 527-1 at 23° C.

4. The composition of claim 1, wherein the polymer base resin comprises polyamide, poly(p-phenylene oxide), polyolefin, polyester, polycarbonate, polyetherimide, polyether ketone, or any of the aforementioned resins comprising a co-monomer which comprises at least one acetylenic moiety, or a combination thereof.

5. The composition of claim 1, wherein the cross-linking agent comprises a plurality of alkene, allylic, acrylate or methacrylate, maleimide, triallyl isocyanurate or trimethallyl isocyanurate groups or combination thereof.

6. The composition of claim 1, wherein the cross-linking agent comprises one molecular species having at least one carbon-carbon triple bond, or a combination of different molecular species each one having at least one carbon-carbon triple bond.

7. The composition of claim 1, wherein the lubricant comprises polytetrafluoroethylene or aramid fiber or silicon oil or graphite or silicon oil or wax or polyolefin or combination thereof.

8. The composition of claim 1, wherein the reinforcing fiber comprises glass fiber, carbon fiber, carbon nanotubes, carbon nano structures, graphene or combinations thereof.

9. The composition of claim 1, wherein the reinforcing filler is present in an amount of between 0-30 wt %.

10. An article comprising a composition of claim 1.

11. The article of claim 10, wherein the article is a gear.

12. A method of preparing a composition comprising:
forming a mixture of from about 40 wt. % to about 99.95 wt. % of a polymer base resin; from 0 wt. % to about 60 wt. % of a reinforcing filler; from 0 wt. % to about 25 wt. % of a lubricant; and from about 0.05 wt. % to about 10 wt. % of a cross-linking agent; and
inducing cross-linking in the mixture to form the composition, wherein the composition exhibits a number of tensile fatigue cycles to failure, measured at at least one of 23° C. and 150° C., a frequency of 5 Hz and a stress ratio of 0.1, that is at least 20% higher than the number of tensile fatigue cycles to failure exhibited by a control composition, corresponding to the untreated composition without the cross-linking agent, when measured under a stress that is at least one of 10% or 20% or 30% or 40% or 50% or 60% or 70% or 80% or 90% of the tensile strength of the control composition, the tensile strength measured according to ISO 527-1; and
wherein the combined weight percent value of all components does not exceed 100 wt % and wherein all weight percent values are based on the total weight of the composition.

13. The method of claim 12, wherein the polymer base resin comprises polyamide, polyolefin, polyester, polycarbonate, polyetherimide, poly(p-phenylene oxide), polyetherketone, or any of the aforementioned resins comprising copolymers which comprise at least one acetylenic moiety, or a combination thereof and the lubricant comprises polytetrafluoroethylene or aramid fiber or silicon oil or graphite or silicon oil or wax or polyolefin or combination thereof.

14. The method of claim 12, wherein the cross-linking agent comprises a plurality of alkene, allylic, acrylate or methacrylate or maleimide groups or combination thereof.

15. The method of claim 12, wherein the cross-linking agent comprises triallyl isocyanurate or trimethallyl isocyanurate or a combination thereof.

16. The method of claim 12, wherein the cross-linking agent comprises one molecular species having at least one carbon-carbon triple bond, or a combination of different molecular species each one having at least one carbon-carbon triple bond.

17. The method of claim 12, wherein inducing cross-linking comprises irradiation of the mixture.

18. The method of claim 17, wherein the irradiation is performed using gamma or beta or x-ray radiation or combination thereof.

19. The method of claim 18, wherein the radiation dose is 25 to 400 kGy.

20. The method of claim 12, wherein inducing cross-linking comprises application of heat at a temperature from 80° C. to 400° C. and for a time from 2 min to 7 days.
